(19) United States
(12) Patent Application Publication
(10) Pub. No.: US 2015/0310617 A1
(43) Pub. Date: Oct. 29, 2015

(54) DISPLAY CONTROL DEVICE AND DISPLAY CONTROL METHOD

(71) Applicant: FUJITSU LIMITED, Kawasaki-shi (JP)

(72) Inventor: Nobuyuki HARA, Meguro (JP)

(73) Assignee: FUJITSU LIMITED, Kawasaki-shi (JP)

(21) Appl. No.: 14/694,331

(22) Filed: Apr. 23, 2015

(30) Foreign Application Priority Data
Apr. 28, 2014 (JP) 2014-092303

(51) Int. Cl. G06T 7/00; H04N 5/232

(52) U.S. Cl. CPC G06T 7/0044; G06T 7/0022; H04N 5/23229; G06T 2207/30204

(57) ABSTRACT

A display control device that calculates an imaging position and an imaging posture of a camera capturing a plurality of captured images with a marker as a reference based on position information of the marker recognized from the captured images, and superimposes and displays augment information on the captured image based on the calculated imaging position and the imaging posture of the camera, the device includes a memory; and a processor to execute a plurality of instructions stored in the memory to perform: acquiring a second captured image captured by the camera on which the augment information is to be superimposed and displayed, and a plurality of first captured images captured by the camera that is captured at a time different from that of the second captured image, and on which the augment information is to be superimposed and displayed; storing an image feature information.

### CROSS-REFERENCE TO RELATED APPLICATION

This application is based upon and claims the benefit of priority of the prior Japanese Patent Application No. 2014-092303 filed on Apr. 28, 2014, the entire contents of which are incorporated herein by reference.

### FIELD

The embodiments discussed herein are related to a display control device and a display control method.

### BACKGROUND

An augmented reality (AR) technology in which a virtual image is superimposed and displayed on a predetermined position on an image obtained by imaging the real space is known. Currently, the AR technology is widely spreading for the use of assisting work of a worker by superimposing and displaying the work assist information indicating work content or a work target position in the working space such as a factory on a captured image. For example, in “Proposal and Evaluation of Decommissioning Support Method of Nuclear Power Plants using Augmented Reality” by Ishii, et al., pages 289 to 290 in Transactions of the Virtual Reality Society of Japan Vol. 13, No. 2, Jun. 30, 2008, it is proposed that the augmented reality technique is used for assisting the dismantling work of machines in the nuclear power plant.

A method of the superimposing and displaying of the work assist information based on the captured image is broadly divided into a “marker based method” in which a known shaped marker displayed on a known real space is used, and a “markerless method” in which such a marker is not used. In the marker based method, for example, when a region where a marker is included is imaged by the worker, a position and a posture (imaging direction) of the camera are determined based on coordinate information of the marker recognized from the captured image. Then, the work assist information corresponding to the marker is superimposed and displayed on the appropriate position corresponding to the determined position and the posture on the image. On the other hand, for example, in the markerless method, information of an unknown feature point is extracted from the image, and the position and the posture of the camera are determined based on the extracted information of the feature point.

In addition, as an example of a technology relating to the image superimposition by the AR technology, in Japanese Laid-open Patent Publication No. 2005-33319, a technology is proposed, in which the position and the posture of the camera are estimated based on the measurement result of the angular velocity during an immediately previous period, and the estimated position and the posture of the camera are modified based on the relationships between the result of detecting the marker from the image and the estimated position and the posture of the camera.

In addition, as an example of an image recognition technology, in Japanese Laid-open Patent Publication No. 2011-175600, a technology is proposed, in which a feature amount of a characteristic portion is extracted from the captured image, a degree of importance of each feature amount is determined from the physical property of each feature portion and a lighting condition at the time of imaging, and then, the position and the posture of the object is recognized based on a value in which each feature amount is weighted by the degree of importance.

### SUMMARY

In accordance with an aspect of the embodiments, a display control device that calculates an imaging position and an imaging posture of a camera capturing a plurality of captured images with a marker as a reference based on position information of the marker recognized from the captured images, and superimposes and displays augment information on the captured image based on the calculated imaging position and the imaging posture of the camera, the device includes a memory; and a processor to execute a plurality of instructions stored in the memory to perform: acquiring a second captured image captured by the camera on which the augment information is to be superimposed and displayed, and a plurality of first captured images captured by the camera that is captured at a time different from that of the second captured image, and on which the augment information is to be superimposed and displayed; storing an image feature information, respectively of the first captured images which is used for calculating a degree of similarity of at least one of the first captured image and the second captured image in a storage, in a case where the marker included in the first captured images are recognized; calculating the imaging position and the imaging posture corresponding to the second captured image based on the image feature information, in a case where the marker included in the second captured image fails to be recognized; and determining, a display position of superimposition of the augment information related to the second captured image based on the calculated imaging position and the calculated imaging posture calculated by the calculating, when the marker included in the second captured image is failed to be recognized.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a diagram illustrating an example of a configuration and processing of a display control device in a first embodiment;

FIG. 2 is a diagram illustrating an example of a hardware configuration of a terminal device in a second embodiment;

FIG. 3 is a diagram illustrating an example of a scene of using the terminal device;

FIG. 4 is a diagram illustrating an example of a superimposed and display of work assist information on an captured image;

FIG. 5 is a diagram illustrating examples of a marker coordinate system, a camera coordinate system, and an image coordinate system;

FIG. 6 is a diagram illustrating a rotation matrix;

FIG. 7 is a diagram illustrating a translation vector;

FIG. 8 is a block diagram illustrating an example of a configuration of processing functions included in the terminal device;

FIG. 9 is a diagram illustrating an example of a configuration of information recorded in a comparison image information database;

FIG. 10 is a flowchart (the first) illustrating an example of a processing procedure of the terminal device;

FIG. 11 is a flowchart (the second) illustrating an example of a processing procedure of the terminal device;

FIG. 12 is a flowchart (the third) illustrating an example of a processing procedure of the terminal device;

FIG. 13 is a block diagram illustrating an example of a configuration of processing functions included in the terminal device in a third embodiment;

FIG. 14 is a diagram illustrating an example of a configuration of information recorded in a comparison image information database;

FIG. 15 is a flowchart illustrating an example of a classification processing procedure by an information accumulation control unit;

FIG. 16 is a flowchart illustrating a part of processing by a comparison image information selection unit in the third embodiment;

FIG. 17 is a diagram illustrating an example of a screen associated with a display of a guide frame;

FIG. 18 is a flowchart illustrating a part of processing by a comparison image information selection unit in the fourth embodiment; and

FIG. 19 is a flowchart illustrating a part of processing by a comparison image information selection unit in the fifth embodiment.

### DESCRIPTION OF EMBODIMENTS

Hereinafter, the embodiments in the present disclosure will be described with reference to the drawings.

### First Embodiment

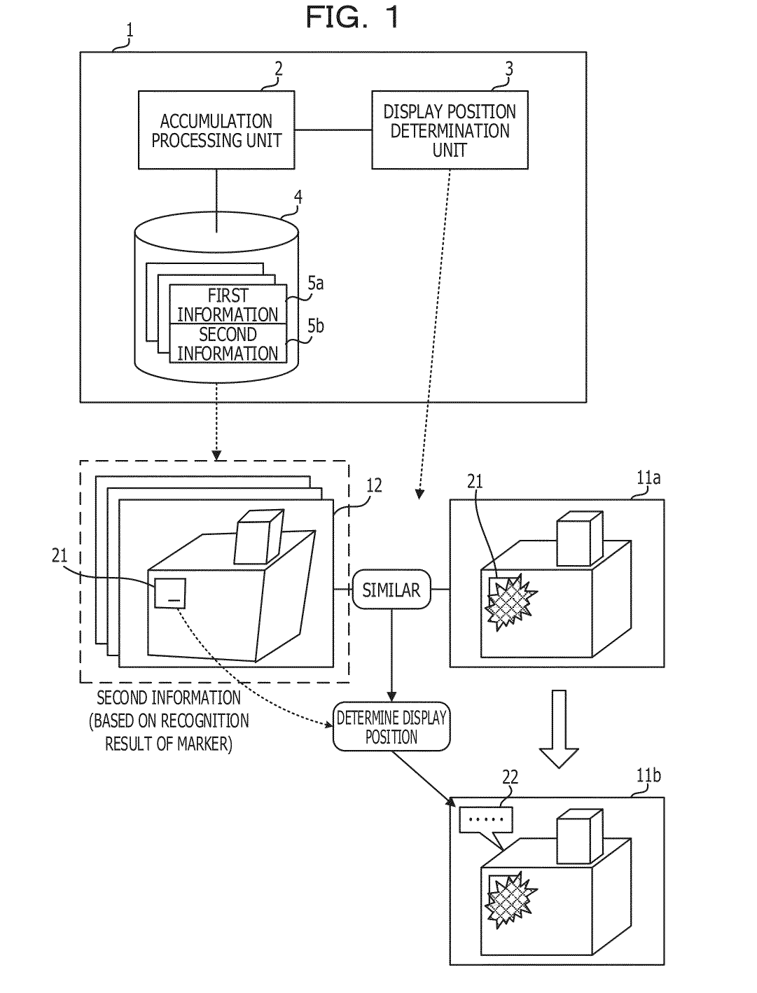

FIG. 1 is a diagram illustrating an example of a configuration and processing of a display control device in a first embodiment. A display control device 1 illustrated in FIG. 1 calculates an imaging position and an imaging posture with a marker as a reference based on position information of the marker recognized by a captured image. Then the display control device 1 causes the predetermined work assist information (in other words, augment information) to be superimposed and displayed on the position based on the calculated imaging position and the imaging posture on the captured image.

For example, a camera and a display device are mounted on the display control device 1, and the display control device 1 is carried by a worker. The operator images a working space including a work target object on which the marker is placed. At this time, the display control device 1 recognizes the marker from the captured image and causes the work assist information to be superimposed and displayed in the above order based on the recognition result.

The work assist information is information that is related to the work such as work content or guidelines for the work and is presented to the worker by virtual image information. The worker may accurately perform the work by viewing the screen on which the work assist information is superimposed and displayed.

In addition, in the processing of superimposed display of the work assist information in the order described above, in a case where the marker is not recognized from the captured image, it is difficult for the display control device 1 to calculate the imaging position and the imaging posture, and as a result, the work assist information may not be superimposed and displayed. The display control device 1 includes an accumulation processing unit 2 and a display position determination unit 3 as functions for enabling the work assist information to be superimposed and displayed on the accurate position on the captured image even in a case where the marker is not recognized from the captured image. In addition, the display position determination unit 3 may include a not illustrated extraction unit, a calculation unit, and a determination unit. The extraction unit, the calculation unit, and the determination unit may perform the below-described processing of the display position determination unit 3 by appropriately sharing the processing in arbitrary units. Furthermore, the display control device 1 may include a not illustrated acquisition unit that acquires the captured image.

The accumulation processing unit 2 records first information (in other words, image feature information) 5a and second information (in other words, position information) 5b in a storage device 4 when the marker is successfully recognized from the captured image during the processing of superimposed display of the work assist information on the captured image as described above. The storage device 4 may be mounted, for example, inside of the display control device 1, or may be provided on outside the display control device 1.

The first information 5a is information relating to the captured image used for calculating a degree of similarity between the captured image from which the marker is successfully recognized and another image. For example, the position and the feature amount of the feature point obtained from the captured image or image data of the captured image are included in the first information 5a. The second information 5b is information based on the result of recognizing the marker from the captured image. For example, position information of the marker in the captured image or the imaging position and the imaging posture calculated from the position information of the marker is included in the second information 5b.

The display position determination unit 3 performs the following processing when the marker fails to be recognized from the captured image. Here, when an captured image 11a illustrated in FIG. 1 is imaged, it is assumed that the marker fails to be recognized.

The display position determination unit 3 extracts the second information 5b that corresponds to the captured image similar to the captured image 11a from the storage device 4 based on the first information 5a for each captured image recorded in the storage device 4. In the example in FIG. 1, it is assumed that an image 12 is specified as the captured image of the past that is similar to the captured image 11a. In this case, the display position determination unit 3 extracts the second information 5b that corresponds to the image 12 from the storage device 4.

A marker 21 that is same as the marker 21 which is to be originally included in the imaging range of the captured image 11a is reflected in the image 12, and the marker 21 is assumed to be recognized from the image 12 in the past. In this case, the extracted second information 5b becomes the information that is based on the result of recognizing the marker 21 from the image 12.

The display position determination unit 3 calculates the imaging position and the imaging posture corresponding to the captured image 11a based on the extracted second information 5b. The calculated imaging position and the imaging posture indicate the imaging position and the imaging posture with the marker 21 that is to be originally reflected on the captured image 11a as the reference. Then, the display position determination unit 3 determines the superimposed display position of work assist information 22 based on the calculated imaging position and the imaging posture.

As described above, the display control device 1 extracts the captured image from which the marker is not recognized from the captured image from which the past marker may be recognized. Then, the display control device 1 determines the superimposed display position of the work assist information 22 using the second information corresponding to the extracted captured image, that is, the information based on the result of recognizing the marker. In this way, even in a case where the marker is not recognized from the captured image 11a, it is possible to superimpose and display the work assist information 22 on accurate position on the captured image 11a.

Particularly, the processing load in the above-described processing of the display control device 1 when the marker is not recognized is lower than that in a case of the method of switching to the markerless method in a point that the imaging position and the imaging posture are not directly calculated based on the natural features extracted from the image. Furthermore, as in the markerless method, the imaging position and the imaging posture in the initial state do not have to be estimated. For this reason, according to the display control device 1, the processing load may be decreased and thus, it is also possible to improve the accuracy of the superimposed display position of the work assist information compared to the case of the method of switching to the markerless method.

### Second Embodiment

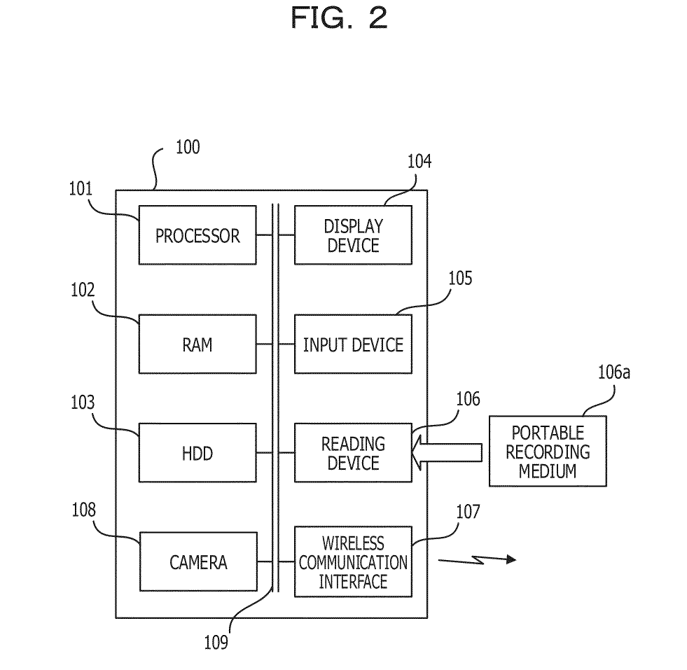

FIG. 2 is a diagram illustrating an example of a hardware configuration of a terminal device in a second embodiment. A terminal device 100 in the second embodiment is realized as a portable computer as illustrated in FIG. 2.

The terminal device 100 illustrated in FIG. 2 is entirely controlled by a processor 101. The processor 101 may be a multiprocessor. The processor 101 is, for example, a central processing unit (CPU), a micro processing unit (MPU), a digital signal processor (DSP), an application specific integrated circuit (ASIC), or a programmable logic device (PLD). In addition, the processor 101 may be a combination of two or more elements among the CPU, MPU, DSP, ASIC, and PLD.

Random access memory (RAM) 102 and a plurality of peripheral devices are connected to the processor 101 via a bus 109.

The RAM 102 is used as a main memory of the terminal device server 100. At least a part of an operating system (OS) program and application programs that are executed by the processor 101 are temporarily stored in the RAM 102. In addition, various data desired for the processing by the processor 101 are stored in the RAM 102.

As the peripheral devices connected to the bus 109, there are a hard disk drive (HDD) 103, a display device 104, an input device 105, a reading device 106, a wireless communication interface 107, and a camera 108.

The HDD 103 is used as an auxiliary storage device of the terminal device 100. The OS program, the application programs, and various data are stored in the HDD 103. Other type of non-volatile storage device such as a solid state drive (SSD) may be used as the auxiliary storage device.

The display device 104 displays an image on the screen according to an instruction from the processor 101. As the display device 104, there is an organic electroluminescence (EL) display and the like.

The input device 105 transmits a signal according to the input operation of the user to the processor 101. As the input device 105, there are, for example, a touch pad that is disposed on the display screen surface of the display device 104, a touch pad, a mouse, a drag ball, an operation key, and the like.

A portable recording medium 106a is detachably attached to the reading device 106. The reading device 106 reads the data recorded in the portable recording medium 106a and transmits the data to the processor 101. As the portable recording medium 106a, there are an optical disk, an optical magnetic disk, a semiconductor memory, and the like.

The wireless communication interface 107 performs the transmission and reception of the data with another device by the wireless communications.

The camera 108 digitalizes an image signal obtained by an imaging element and transmits the digitalized signal to the processor 101.

The processing functions of the terminal device 100 may be realized by the hardware configuration described above.

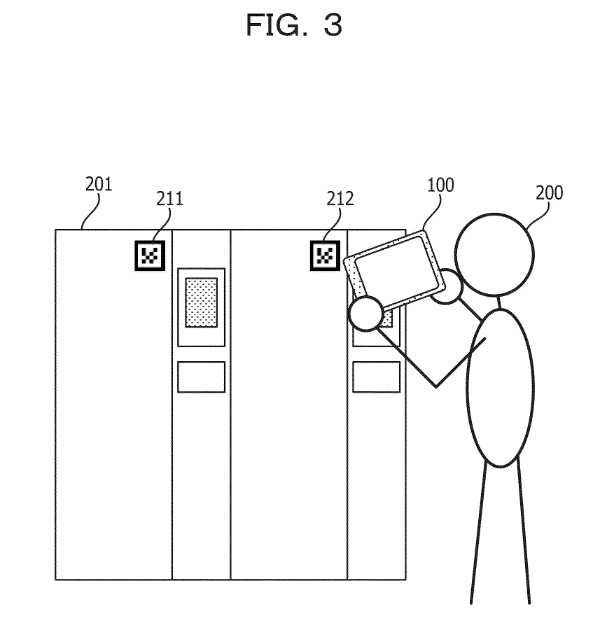

FIG. 3 is a diagram illustrating an example of a scene of using the terminal device. A worker 200 carries the terminal device 100 in a working space where a work target object 201 that is a work target exists. A predetermined maker is attached to the work target object 201 for each step of work. In the example in FIG. 3, two markers 211 and 212 are illustrated. The outer shapes and the sizes of each marker are the same, and here, each marker is assumed to have rectangular shapes respectively having the same long sides and short sides. In addition, the outer edge of each marker is assumed to be bordered by lines having the same thickness and the same color. Furthermore, information indicated inside of the marker (internal pattern) is different from each marker.

In the terminal device 100, the camera 108 is attached, for example, on the rear surface side opposite to the display screen surface of the display device 104. The worker 200 holds the terminal device 100 to the work target object 201 and images the work target regions including the marker using the camera 108. Then, the terminal device 100 recognizes the marker from the captured image. Since the internal patterns of the markers are different from each other for each marker, the terminal device 100 may specify a working step from the result of recognizing the internal pattern of the marker. The terminal device 100 reads the work assist information associated with the specified working step, and causes the read work assist information to be superimposed and displayed on the appropriate position of the captured image based on the result of recognizing the marker.

In FIG. 3, only one work target object 201 is illustrated as an example. However, it is needless to say that there may be a plurality of work target objects.

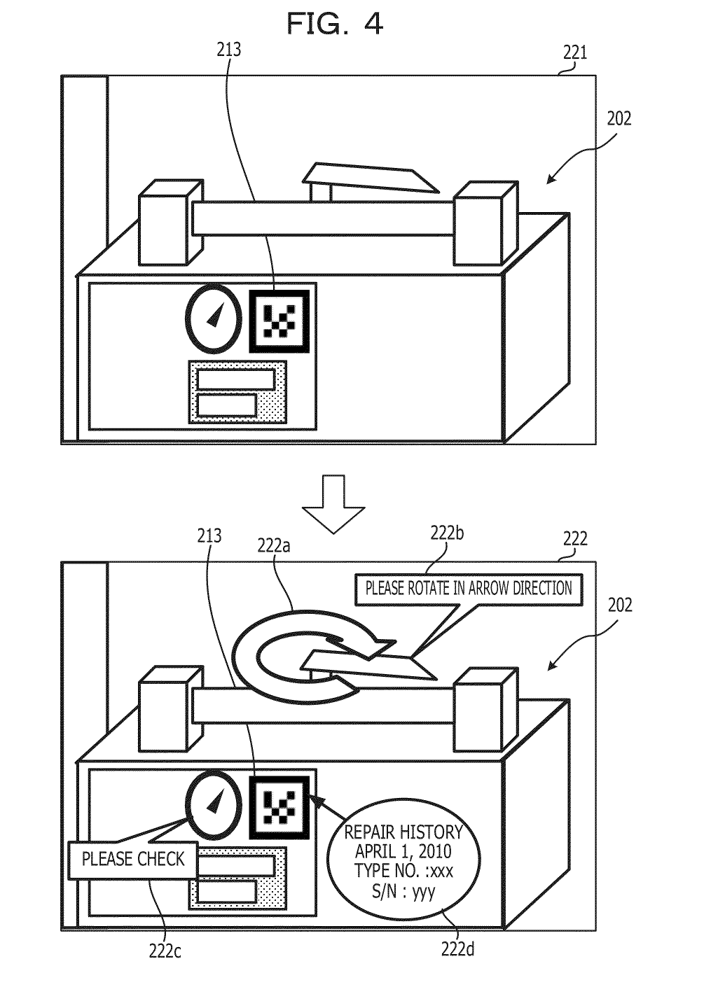

FIG. 4 is a diagram illustrating an example of a superimposed and display of work assist information with respect to the captured image. As described above, the terminal device 100 basically causes the work assist information associated with the marker to be superimposed and displayed on the appropriate position of the captured image based on the result of recognizing the marker from the captured image. That is, the terminal device 100 usually performs the superimposed display processing of the work assist information using the marker based AR technology.

An image 221 on the upper side of FIG. 4 is an example of an image obtained by imaging a work target object 202 to which the marker 213 is attached. The terminal device 100 recognizes the marker 213 from the image 221. At this time, the terminal device 100 detects the coordinates of four vertices on the image 221 in the outer shape of the marker 213, and calculates the information indicating the imaging position and the imaging posture of the camera 108 based on the coordinates of the vertices. Hereinafter, in some cases, the information indicating the imaging position and the imaging posture of the camera 108 is referred to as “imaging position and posture information”.

The terminal device 100 determines the working step based on the display information inside of the marker 213 and specifies the work assist information corresponding to the determined working step. The terminal device 100 causes the specified work assist information on the appropriate position on the image 221 calculated from the imaging position and posture information. An image 222 on the lower side of FIG. 4 illustrates an example of a case where the work assist information items 222a to 222d corresponding to the marker 213 are superimposed and displayed with respect to the image 221. For example, the work assist information 222a guides the worker through the direction of rotating the predetermined portion (a handle) of the work target object 202 by an image of arrow. In addition, the work assist information items 222b to 222d presents the work content or the information related to the work to the worker by the character information.

Here, a three dimensional coordinate system with the center of the marker as an origin will be referred to as “marker coordinate system”. The imaging position and posture information calculated by the terminal device 100 is expressed as information in the marker coordinate system. That is, the imaging position and posture information is information indicating the position from which the marker is imaged and the direction in which the marker is imaged with the center of the marker as the reference. In addition, the position information that causes the work assist information to be superimposed and displayed is stored in the terminal device 100 as the position information in the marker coordinate system.

The shape and the size of the marker reflected on the captured image vary according to the imaging position and posture information. Therefore, the terminal device 100 may calculate the imaging position and posture information based on the position of the vertices of the marker on the captured image. Then, in a case where the terminal device 100 assumes that the work assist information exists on the designated position on the space that the marker coordinate system indicates, and the work assist information is imaged from the position where the calculated imaging position and posture information indicates, the terminal device 100 calculates the position on the captured image where the work assist information is reflected and the shape of the reflected work assist information. In this way, it is possible to superimpose and display the work assist information on the appropriate position on the captured image according to the position and imaging direction of camera 108 with respect to the marker.

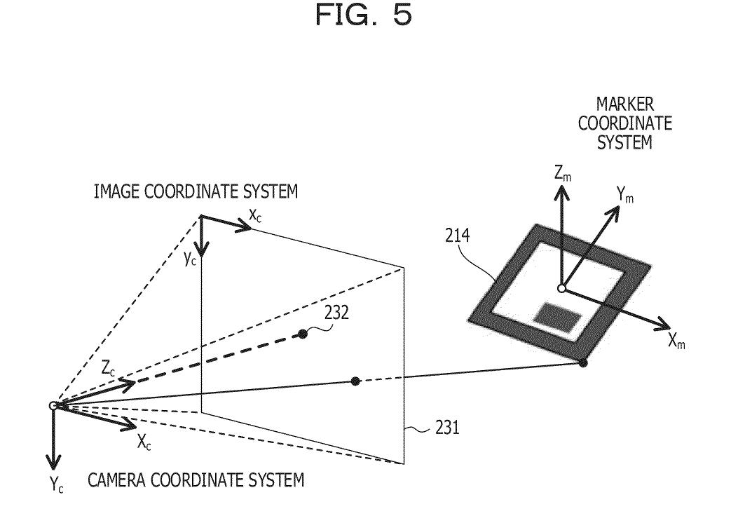

Here, the method of calculating the position at the time when the work assist information is superimposed and displayed on the captured image will be described using FIG. 5 to FIG. 7.

FIG. 5 is a diagram illustrating examples of a marker coordinate system, a camera coordinate system, and an image coordinate system. In FIG. 5, the marker coordinate system with the surface of the marker 214 as the X-Y plane and the center of the marker 214 as the origin is defined as a matrix [Xₘ Yₘ Zₘ 1]^{T}. The upper right “T” indicates a transposed matrix. In addition, a three dimensional “camera coordinate system” with the focus of the camera as the origin and the center of the imaging direction as the X-axis is defined as a matrix [X_{c} Y_{c} Z_{c} 1]^{T}. Furthermore, a two dimensional “image coordinate system” with the upper left of the captured image as the origin is defined as a matrix [x_{c} y_{c} 1]^{T}. The Z-axis in the camera coordinate system is orthogonal to an image plane 231 in the image coordinate system at the center point 232 of the captured image.

The position information of the marker in the captured image is expressed as the position information in the image coordinate system. In addition, as described above, imaging position and posture information of the camera that is determined based on the position information of the marker may be expressed as the focus position and the direction (imaging direction) of the camera in the marker coordinate system.

A coordinate transformation between the marker coordinate system and the camera coordinate system is defined as, for example, as the following Equation 1.

$$[ \begin{matrix}{X}_{c} \\ {Y}_{c} \\ {Z}_{c} \\ 1\end{matrix} ] = [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ] [ \begin{matrix}{X}_{m} \\ {Y}_{m} \\ {Z}_{m} \\ 1\end{matrix} ] = [ \begin{matrix}R & T \\ 000 & 1\end{matrix} ] [ \begin{matrix}{X}_{m} \\ {Y}_{m} \\ {Z}_{m} \\ 1\end{matrix} ] \qquad ( 1 )$$

In Equation 1, R indicates a rotation matrix of 3 rows and 3 columns. In addition, T indicates a translation vector, and is expressed as a matrix of 3 rows and 1 column.

Next, a projective transformation from the camera coordinate system to the image coordinate system is defined as following Equation 2. In addition, the matrix P in Equation 2 expressed as Equation 3.

$$\begin{matrix}[ \begin{matrix}{hx}_{c} \\ {hy}_{c} \\ h \\ 1\end{matrix} ] = P [ \begin{matrix}{X}_{c} \\ {Y}_{c} \\ {Z}_{c} \\ 1\end{matrix} ] & ( 2 ) \\ P = [ \begin{matrix}{P}_{11} & {P}_{12} & {P}_{13} & 0 \\ 0 & {P}_{22} & {P}_{23} & 0 \\ 0 & 0 & 1 & 0 \\ 0 & 0 & 0 & 1\end{matrix} ] & ( 3 )\end{matrix}$$

h in Equation 2 indicates a scalar. In addition, the matrix P indicates an internal parameter calculated from the focal distance and the angle of view that are obtained by the camera calibration. For example, the matrix P may be obtained in advance from the captured image obtained by imaging the marker in a state that the known sized marker is installed at the known distance.

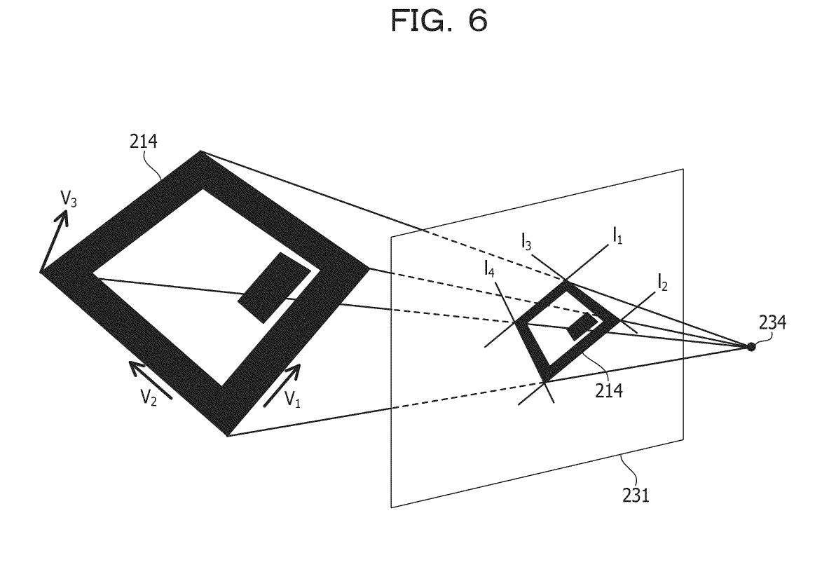

FIG. 6 is a diagram illustrating the rotation matrix. Straight lines lᵢ (i=1, 2, 3, and 4) that respectively indicate four sides of the marker 214 may be obtained from the coordinates of four vertices of the marker 214 in the captured image.

Here, for example, following Equations 4-1 and 4-2 are given to the sides l₁ and l₂ of the marker 214, respectively.

l₁:a₁x_{c}+b₁y_{c}+c₁=0 (4-1)

l₂:a₂x_{c}+b₂y_{c}+c₂=0 (4-2)

From Equations 2, 3, 4-1, and 4-2, following Equations 5-1 and 5-2 may be obtained.

a₁P₁₁X_{c}+(a₁P₁₂+b₁P₂₂)Y_{c}+(a₁P₁₃+b₁P₂₃+c₁)Z_{c}=0 (5-1)

a₂P₁₁X_{c}+(a₂P₁₂+b₂P₂₂)Y_{c}+(a₂P₁₃+b₂P₂₃+c₂)Z_{c}=0 (5-2)

Equation 5-1 expresses a surface S₁ passing through the sides of the marker 214 corresponding to the straight line l₁ and the focus 234 of the camera 108. In addition, Equation 5-2 expresses a surface S₂ passing through the sides of the marker 214 corresponding to the straight line l₂ and the focus 234 of the camera 108. From Equation 5-1 and 5-2, an Equation respectively indicating normal vectors n₁ and n₂ of the surfaces S₁ and S₂ may be obtained. Then, if the direction vector of the sides of the marker 214 corresponding to the straight line l₁ is assumed to be V₁, the direction vector is given from the cross product of the normal vectors n1 and n2.

The same calculation will be performed regarding the straight lines l₃ and l₄, and thus, the direction vector V₂ may be obtained. Furthermore, the direction vector V₃ orthogonal to the plane including the direction vector V₁ and V₂ is determined. The rotation matrix R of above Equation 1 may be obtained as R=[V₁ V₂ V₃]

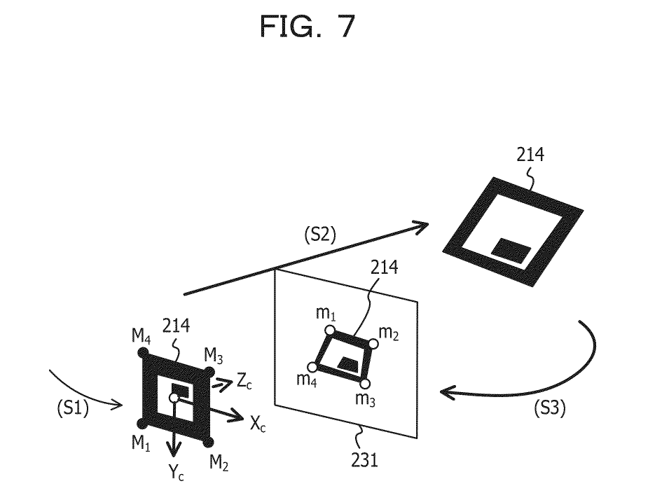

FIG. 7 is a diagram illustrating a translation vector. In FIG. 7, it is considered that the marker 214 is disposed in the camera coordinate system such that the center of the marker 214 is coincident with the origin of the camera coordinate system (step S1), the marker 214 is rotated by the rotation matrix R, translated by the translation vector T (step S2), and then, projected on the captured image on the image plane 231 by the matrix P (step S3).

The three dimensional coordinate of the marker 214 in the marker coordinate system is assumed to be Mᵢ (here, i=1, 2, 3, 4), and the two dimensional coordinate of the vertex of the marker 214 on the captured image is assumed to be mᵢ (here, i=1, 2, 3, 4). When the vertex of the marker 214 in the marker coordinate system is expressed as a matrix [Mᵢₓ M_{iy} M_{iz}]^{T} (here, i=1, 2, 3, 4), and the vertex of the marker 214 on the captured image is expressed as a matrix [mᵢₓ m_{iy}]^{T} (here, i=1, 2, 3, 4), Equation 6 is obtained as follows using the Equations 1 and 2 described above.

$$[ \begin{matrix}{hm}_{ix} \\ {hm}_{iy} \\ h \\ 1\end{matrix} ] = [ \begin{matrix}{P}_{11} & {P}_{12} & {P}_{13} & 0 \\ 0 & {P}_{22} & {P}_{23} & 0 \\ 0 & 0 & 1 & 0 \\ 0 & 0 & 0 & 1\end{matrix} ] [ {R [ \begin{matrix}{M}_{ix} \\ {M}_{iy} \\ {M}_{iz}\end{matrix} ] + [ \begin{matrix}{t}_{x} \\ {t}_{y} \\ {t}_{z}\end{matrix} ]}_{1} ] \qquad ( 6 )$$

A simultaneous linear equation with (tₓ, t_{y}, t_{z}) as unknowns may be obtained by developing the Equation 6 using a length of one side of the marker 214 in the camera coordinate system and performing such processing with regard to each side. By solving this simultaneous linear equation, the translation vector T [tₓ, t_{y}, t_{z}] may be obtained.

According to the procedures described in FIG. 6 and FIG. 7, the rotation matrix R and the translation vector T of Equation 1 may be obtained from the coordinate of four vertices of the marker 214 on the captured image.

Next, based on above Equation 2, the coordinate of the point in the image coordinate system may be expressed as Equations 7-1 and 7-2 using the coordinate of the point in the camera coordinate system.

$$\begin{matrix}{x}_{c} = \frac{{P}_{11} {X}_{c} + {P}_{12} {Y}_{c} + {P}_{13} {Z}_{c}}{{Z}_{c}} & ( 7 \text{-} 1 ) \\ {y}_{c} = \frac{{P}_{22} {Y}_{c} + {P}_{23} {Z}_{c}}{{Z}_{c}} & ( 7 \text{-} 2 )\end{matrix}$$

The position information of the image data that indicates the work assist information is defined according to the coordinate of the marker coordinate system and stored in the terminal device 100. Therefore, by transforming the coordinate information of the stored work assist information to the coordinate information in the camera coordinate system using the Equation 1, and again by transforming to two dimensional coordinate information in the image coordinate system using the Equations 7-1 and 7-2, it is possible to calculate the display position of the work assist information in the captured image.

The data indicating the work assist information stored in the terminal device 100 includes, for example, the image data for each coordinate on the inside of the shape to be displayed (for example, RGB data) and the display position information of the work assist information with the center of the marker 214 as the reference.

Among these, display position information of the work assist information may be stored as, for example, a three dimensional coordinate in the marker coordinate system. In addition, display position information of the work assist information may be stored as each value of the translation component and the rotation axis component. Hereinafter, the latter case will be described.

When the display position of the work assist information in the marker coordinate system is expressed as (Xₘ, Yₘ, Zₘ, 1) and the image data is expressed as (x, y, z, 1), the following Equation 8 is formed.

[Xₘ Yₘ Zₘ 1]^{T}=M[x y z 1]^{T} (8)

If M is assumed to be a transformation matrix expressed in Equation 9, the translation component p (tₓ, t_{y}, t_{z}) and the rotation axis component (rotation angle) (l, m, n, θ) of the work assist information are expressed as the following Equations 10 and 11.

$$\begin{matrix}M = T ( p ) R ( l , m , n , θ ) T ( - p ) & ( 9 ) \\ T ( p ) = T ( {t}_{x} , {t}_{y} , {t}_{z} ) = [ \begin{matrix}1 & 0 & 0 & {t}_{x} \\ 0 & 1 & 0 & {t}_{y} \\ 0 & 0 & 1 & {t}_{z} \\ 0 & 0 & 0 & 1\end{matrix} ] & ( 10 ) \\ R ( l , m , n , θ ) = [ \begin{matrix}{l}^{2} + ( 1 - {l}^{2} ) cos θ & lm ( 1 - cos θ ) - n sin θ & ln ( 1 - cos θ ) + m sin θ & 0 \\ lm ( 1 - cos θ ) + n sin θ & {m}^{2} + ( 1 - {m}^{2} ) cos θ & mn ( 1 - cos θ ) - l sin θ & 0 \\ ln ( 1 - cos θ ) - m sin θ & mn ( 1 - cos θ ) + l sin θ & {n}^{2} + ( 1 - {n}^{2} ) cos θ & 0 \\ 0 & 0 & 0 & 1\end{matrix} ] & ( 11 )\end{matrix}$$

Incidentally, in a case where the terminal device 100 performs the processing of superimposed display of the information based on the result of recognizing the marker, if the marker is not recognized from the captured image, the imaging position and posture information may not be calculated, and thus, it is not possible to perform the superimposed display of the information.

As the case where the recognition of the marker is not possible, for example, the case where dirt generated during the work is attached to the marker or the case where the marker is placed in the shadowed position in which the illumination does not easily reach, may be considered. In the cases described above, solutions such as replacing the dirt-attached marker or improving the environment around the marker such that the difference in brightness does not occur around the marker may be considered. However, there is a problem in that it is difficult to immediately address any of the above solutions.

In addition, in a case where the marker is not recognized from the captured image, the changing of the method to the markerless method may be considered. However, the processing load in the markerless method is greater than that in the marker based AR. In addition, in the markerless method, in order to correspond to various positions and postures and improve the robustness to environmental changes, a large amount of template information has to be prepared. For this reason, if the superimposed position accuracy is intended to be maintained equivalent to that in the marker based method, the cost for developing and manufacturing of the device increases. Therefore, when the method is changed to the markerless method, it is difficult to maintain the superimposed position accuracy equivalent to that in the marker based method in reality.

Furthermore, in the markerless method, the estimation of the imaging position and the imaging posture at the initial stage is performed. Since the accuracy of the estimation of the imaging position and the imaging posture at the initial stage influences the accuracy of the superimposed position accuracy thereafter, the estimation has to be performed with high accuracy. Accordingly, there is a method in which the estimation of the imaging position and the imaging posture at the initial stage is performed based on the result of recognizing the marker. However, it is difficult to use such a method in a case where the marker is not recognized from the current captured image. In addition, a method in which the result of recognizing the marker that has been recognized most recently is used may be considered. However, since there may be errors in the result of the recognition according to the environment of the condition at the time of the recognition of the marker, there is a possibility that the accuracy of estimating the imaging position and the imaging posture deteriorates.

Therefore, in the present embodiment, the terminal device 100 accumulates the information of the result of recognizing the marker and the feature amount from the captured image from which the marker is successfully recognized into the storage device. In addition, in a case where the marker fails to be recognized, the terminal device 100 compares the information of the feature amount accumulated in the storage device and the information extracted from the current image, and specifies an image that is similar to the current image among the past captured images from which the marker is successfully recognized. Then, the terminal device 100 acquires the result of recognizing the marker of the specified image from the storage device, estimates the imaging position and posture information corresponding to the current image using the acquired result of recognizing the marker, and then, determines the superimposed display position of the work assist information. As described above, the terminal device 100 may accurately determine the superimposed display position of the work assist information by using the result of recognizing the marker from the image similar to the current image among the past captured images in which the marker is successfully recognized.

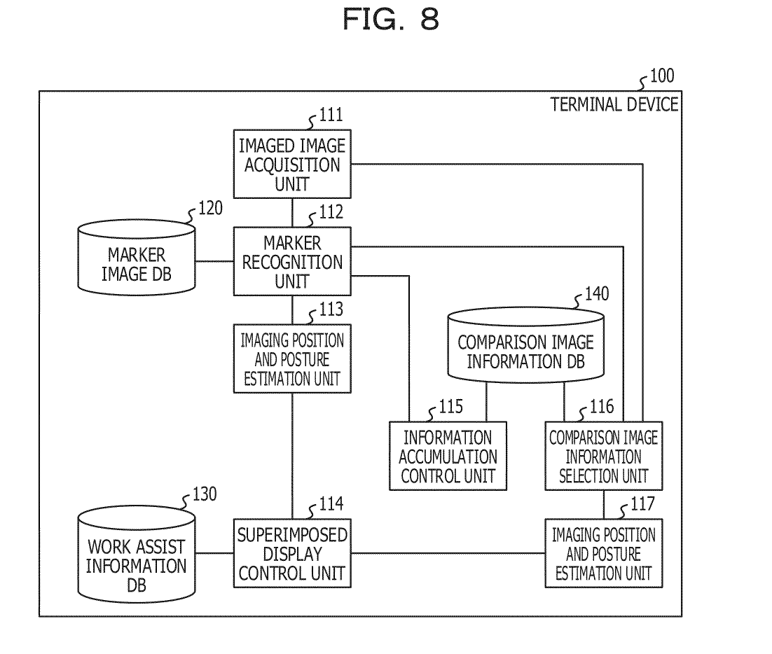

FIG. 8 is a block diagram illustrating an example of a configuration of processing functions included in the terminal device.

The terminal device 100 includes an captured image acquisition unit 111, a marker recognition unit 112, an imaging position and posture estimation unit 113, a superimposed display control unit 114, an information accumulation control unit 115, a comparison image information selection unit 116, and an imaging position and posture estimation unit 117. The processing of each block described above is realized by the predetermined program being executed by the processor 101.

In addition, a marker image database (DB) 120, a work assist information database 130, and a comparison image information database 140 are stored in the storage unit (for example, HDD 103) in the terminal device 100.

The captured image acquisition unit 111 acquires image data of the captured image from the camera 108.

A template image used for the processing of recognizing the marker is stored in the marker image database 120. In the marker image database 120, template images of a plurality of markers of which the internal patterns are different from each other, and each template image corresponds to one working step. Hereinafter, it is assumed that each working step is identified by a work ID, and in the marker image database 120, the template image is respectively associated with each individual work ID.

The marker recognition unit 112 recognizes the marker from the captured image acquired by the captured image acquisition unit 111 using the template image in the marker image database 120. The marker recognition unit 112 recognizes the marker by, for example, extracting the contour of the marker from the captured image, and then, recognizes the internal pattern of the marker by matching with the template image. As a result, the marker recognition unit 112 outputs the coordinate information of four vertices of the marker in the captured image and the work ID corresponding to the recognized internal pattern.

The imaging position and posture estimation unit 113 calculates the imaging position and posture information based on the coordinate information of four vertices of the marker recognized by the marker recognition unit 112. As described above, the imaging position and posture information is information indicating the position and the posture (imaging direction) of the camera 108 with the center of the marker as the reference in the marker coordinate system.

In the work assist information database 130, data indicating the work assist information which is to be superimposed and displayed on the captured image is stored. As described above, data indicating the work assist information includes, for example, the image data for each coordinate in the inside of the shape to be displayed and the display position information of the work assist information. The display position information of the work assist information is defined as the value in the marker coordinate system with the center of the corresponding marker as the reference.

The data indicating the work assist information is associated with the work ID. In addition, the data indicating a plurality of work assist information items may be associated with one work ID.

The superimposed display control unit 114 acquires the work ID recognized by the marker recognition unit 112 via the imaging position and posture estimation unit 113, and specifies the work assist information that is corresponding to the acquired work ID, from the work assist information database 130. The superimposed display control unit 114 calculates the display position in the captured image of the specified work assist information based on the imaging position and posture information calculated by the imaging position and posture estimation unit 113, and then, causes the imaging position and posture information to be displayed on the calculated position.

In the period in which the marker is not recognized from the captured image, the superimposed display control unit 114 acquires the imaging position and posture information from the imaging position and posture estimation unit 117, not from the imaging position and posture estimation unit 113.

In a case where the marker recognition unit 112 successfully recognizes the marker from the captured image, the information accumulation control unit 115 records the information relating to the captured image in the comparison image information database 140. In the information recorded in the comparison image information database 140, the recognized work ID, the position and the feature amount of the feature point extracted from the captured image, and the position information of the recognized marker are included.

Hereinafter, in some times, the captured image from which the marker is successfully recognized and of which the related information is recorded in the comparison image information database 140 is referred to as “comparison image”.

In a case where the marker recognition unit 112 fails to recognize the marker from the captured image, the comparison image information selection unit 116 selects the information of an appropriate comparison image used for estimating the imaging position and posture information from the comparison image information database 140. Hereinafter, in some cases, the captured image from which the marker failed to be recognized is referred to as a “recognition failed image”.

Specifically, the comparison image information selection unit 116 performs the following processing. First, the comparison image information selection unit 116 calculates the degree of similarity between the recognition failed image and the comparison image based on the position and the feature amount of the feature point recorded in the comparison image information database 140. The comparison image information selection unit 116 specifies the comparison image of which the degree of similarity to the recognition failed image satisfies the predetermined condition.

Next, from the specified comparison image, the comparison image information selection unit 116 evaluates the corresponding relationships between the feature point in the comparison image and the feature point extracted from the recognition failed image, and selects the comparison image of which the evaluation result satisfies a predetermined condition. In above described evaluation, the transformation matrix in which the coordinate of the feature point in the comparison image is transformed to the coordinate of the feature point in the recognition failed image. Here, the feature point may be features for which a so-called descriptor that is a feature amount vector for each feature is calculated. For example, scale invariant feature transform (SIFT) features or speeded up robust features (SURF) may be used.

The comparison image information selection unit 116 calculates the transformation matrix from the coordinates of each feature point of the specified comparison image and the recognition failed image. As the transformation matrix, a homograph transformation matrix described below may be used. The comparison image information selection unit 116 compares the result of the transformation in which the coordinate of the feature point in the comparison image is transformed by the transformation matrix, and evaluates the accuracy of the transformation based on the distance between those feature points.

The comparison image information selection unit 116 selects the comparison image of which the evaluation value of the accuracy of the transformation satisfies the predetermined condition among the specified comparison images specified using the similarity. The comparison image information selection unit 116 reads the position information of the marker corresponding to the selected comparison image from the comparison image information database 140, and outputs the position information to the imaging position and posture estimation unit 117.

Based on the position information of the marker output from the comparison image information selection unit 116, the imaging position and posture estimation unit 117 calculates the imaging position and the imaging posture by the same procedure as that of the imaging position and posture estimation unit 113, and then, outputs the calculated imaging position and the imaging posture to the superimposed display control unit 114.

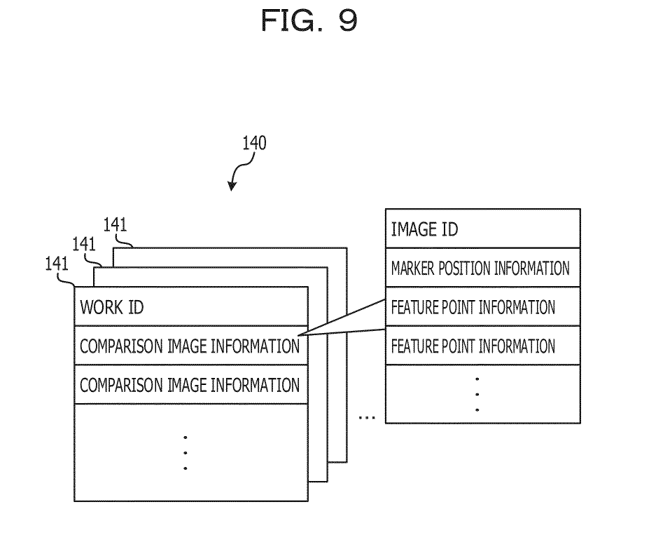

FIG. 9 is a diagram illustrating an example of a configuration of information recorded in a comparison image information database.

A record 141 for each work ID is provided in the comparison image information database 140. One or more comparison image information items are registered in each record 141 in association with the work ID. The comparison image information is the information corresponding to each comparison image (that is, the captured image from which the marker is successfully recognized).

An image ID, marker position information, and a plurality of feature point information items are registered in each comparison image information. The image ID is information that identifies the comparison image. The marker position information includes the coordinates of four vertices with regard to the marker recognized from the comparison image. The information recognized by the marker recognition unit 112 is registered as the marker position information. The feature point information includes the coordinate and the feature amount of the feature point extracted from the comparison image. The coordinate and the feature amount of the feature point are detected from the comparison image by the information accumulation control unit 115.

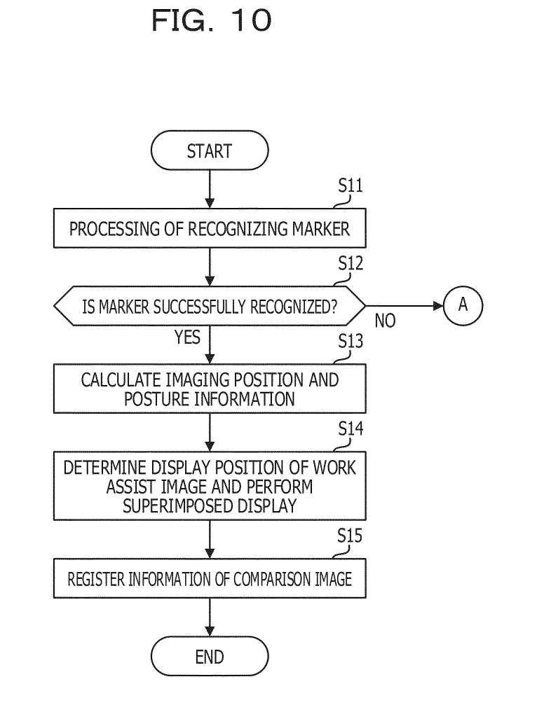

Next, the processing by the terminal device 100 will be described using a flowchart. FIG. 10 to FIG. 12 are flowcharts illustrating examples of processing procedures of the terminal device.

[Step S11] The captured image acquisition unit 111 acquires the image data of the captured image from the camera 108. The marker recognition unit 112 performs the processing of recognizing the marker from the captured image acquired by the captured image acquisition unit 111 using the template image in the marker image database 120.

[Step S12] It is determined whether or not the captured image acquisition unit 111 successfully recognizes the marker. In a case where the marker is successfully recognized, the processing in step S13 is performed. In addition, in a case where the marker fails to be recognized, the processing in step S21 is performed.

[Step S13] The imaging position and posture estimation unit 113 acquires the coordinate information of four vertices of the marker from the marker recognition unit 112. The imaging position and posture estimation unit 113 calculates the imaging position and posture information using the acquired coordinate information. The calculated imaging position and posture information corresponds to the above-described rotation matrix R and the translation vector T.

[Step S14] The superimposed display control unit 114 acquires the work ID recognized by the marker recognition unit 112 via the imaging position and posture estimation unit 113, and specifies the work assist information corresponding to the acquired work ID from the work assist information database 130. The superimposed display control unit 114 calculates the display position in the captured image of the specified work assist information using the above-described Equations 1, 7-1, and 7-2 based on the imaging position and posture information calculated by the imaging position and posture estimation unit 113. The superimposed display control unit 114 causes the imaging position and posture information to be displayed on the calculated display position in the captured image.

[Step S15] The information accumulation control unit 115 acquires the comparison image (that is, the image from which the marker is successfully recognized) data, the marker position information, and the recognized work ID from the marker recognition unit 112. The information accumulation control unit 115 registers the acquired marker position information in the record 141 corresponding to the acquired work ID in the comparison image information database 140. In addition, the information accumulation control unit 115 extracts the feature point from the comparison image, and registers the position information and the feature information of the extracted feature point in the same record 141.

The processing in step S15 may be performed prior to the processing in step S14 or step S13. In addition, the processing in step S15 may be performed in parallel with the processing in step S13 or step S14. Furthermore, the processing in step S15 may be performed, for example, as follows. The information accumulation control unit 115 performs the processing of registering the work ID and the marker position information out of the processing in step S15 triggered by the determination that the marker is successfully recognized in step S12. In addition, at any timing after the registration processing, the information accumulation control unit 115 performs the processing of extracting the feature point from the comparison image and the processing of registering the position information and the feature information of the extracted feature point.

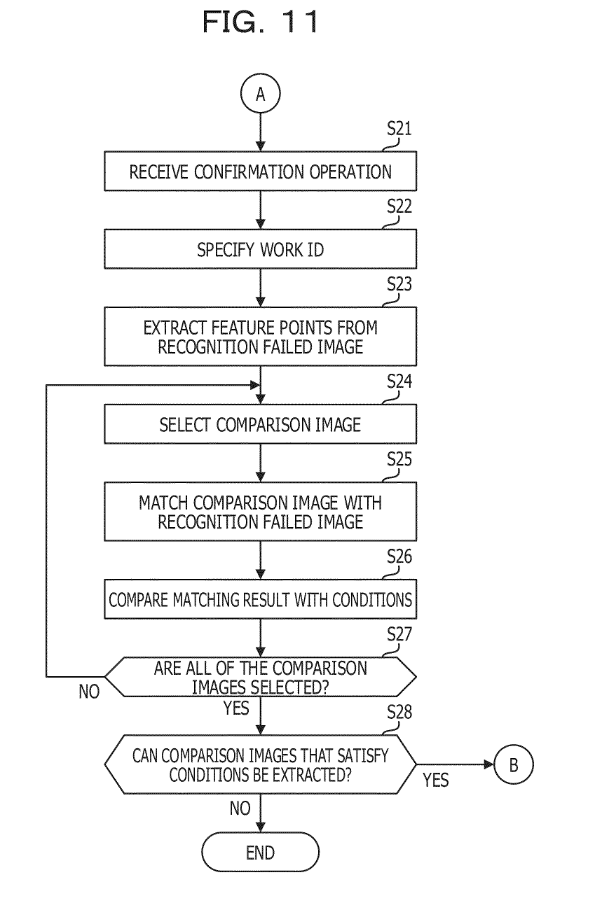

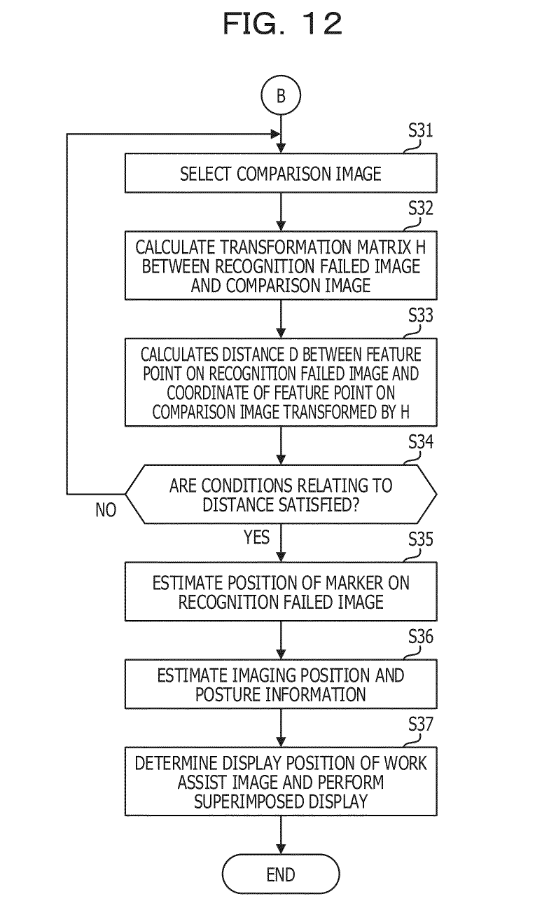

Next, the processing in a case where the marker is not recognized will be described using FIG. 11 and FIG. 12. The processing in a case where the marker is not recognized includes: the processing of extracting the comparison image that is similar to the recognition failed image (FIG. 11); and the processing of evaluating the accuracy of the coordinate transformation between the extracted comparison image and the recognition failed image and selecting the comparison image that is optimal for estimating the imaging position and posture information (steps S31 to 34 in FIG. 12).

[Step S21] When the marker recognition unit 112 fails to recognize the marker, the comparison image information selection unit 116 causes the information notifying of the failure in recognizing the marker and the information for instructing to operate the confirmation button to be displayed on the display device 104. For example, in a case where the display device 104 is a touch panel, the confirmation button is displayed on the screen of the display device 104. In a case where the pressing operation of the confirmation button by the worker is detected, the processing in step S22 is performed.

In the processing subsequent to step S22, the captured image acquired in step S11 may be a processing target as the “recognition failed image”. However, since a certain extent of time elapses from step S11 due to the time for waiting for the operation of the confirmation button, the recognition failed image may be set as follows. When the operation of pressing the confirmation button is detected, the comparison image information selection unit 116 acquires a new captured image from the captured image acquisition unit 111. In the processing subsequent to step S22, the captured image acquired as described above becomes the processing target as the recognition failed image.

[Step S22] The comparison image information selection unit 116 specifies the work ID that indicates the current working step.

For example, in a case where the terminal device 100 has a function of managing the progress of the work, in step S22, the work ID indicating the working step next to the work-completed working step is specified. In addition, the work ID may be input by the input operation of the worker.

[Step S23] The comparison image information selection unit 116 extracts a plurality of feature points from the recognition failed image. The comparison image information selection unit 116 temporarily records the position and the feature amount of the feature points, for example, in RAM 102.

[Step S24] The comparison image information selection unit 116 selects one comparison image from the comparison images that are associated with the work ID specified in step S22 with reference to the comparison image information database 140. In practice, one image ID indicating the comparison image is selected from the record 141 corresponding to the specified work ID in the comparison image information database 140.

[Step S25] The comparison image information selection unit 116 performs processing of matching the comparison image selected in step S24 with the recognition failed image.

Specifically, the comparison image information selection unit 116 reads the feature point information that is associated with the image ID selected in step S23 from the comparison image information database 140. The comparison image information selection unit 116 performs the processing of matching the feature point of the comparison image indicated by the feature point information with the feature point extracted from the recognition failed image in step S23. In the matching processing, for example, a pair of feature points that corresponds each other between the images is specified from the positional relationships between the feature points in each of the images, and it is determined whether or not the difference of the feature amounts of the specified pair of feature points is within a threshold value Ta (here, Ta is larger than zero). In a case where the pair of feature points is specified from the positional relationships and in a case where it is determined that the difference of the feature amounts of the specified pair of feature points is within the threshold value Ta, it is determined that one set of matching succeeds.

[Step S26] The comparison image information selection unit 116 compares the matching result with, for example, following two determination conditions. As a first determination condition, it is determined whether or not a rate of the number of successful matches with respect to the total number of feature points extracted from the recognition failed image is larger than a threshold value Tb (here, Tb is larger than zero and equal to or smaller than one). As a second determination condition, it is determined whether or not the number of successful matches is larger than a threshold value Tc (here, Tc is larger than zero).

The comparison image information selection unit 116 determines whether or not the matching result which comes using the comparison image selected in step S24 satisfies both of the two above-described conditions.

[Step S27] The comparison image information selection unit 116 determines whether or not all of the comparison images of which the information is registered in the comparison image information database 140 and which correspond to the relevant work ID are selected. In a case where all of the comparison images are selected, the processing in step S28 is performed. On the other hand, in a case where there remain non-selected comparison images, the processing in step S24 is performed.

[Step S28] The comparison image information selection unit 116 determines whether or not one or more comparison images that satisfy the determination conditions indicated in step S26 may be extracted. In a case where one or more comparison images that satisfy the determination conditions may be extracted, processing in step S31 is performed. On the other hand, when even one comparison image that satisfies the determination conditions is not extracted at all, the processing ends. In the latter case, for example, the comparison image information selection unit 116 may cause instruction information saying “Please try again to image around the marker” to be displayed on the display device 104.

[Step S31] The comparison image information selection unit 116 selects one comparison image from the comparison images that satisfy the determination conditions indicated in step S26. Actually, the image ID indicating the comparison image is selected.

[Step S32] The comparison image information selection unit 116 calculates a transformation matrix H using a pair of feature points for which the matching between the selected comparison image and the recognition failed image is succeeded. This transformation matrix H is a homograph matrix for transforming the coordinate on the comparison image to the coordinate on the recognition failed image.

The transformation matrix H is defined as following Equation 12.

$$H = [ \begin{matrix}{H}_{11} & {H}_{12} & {H}_{13} \\ {H}_{21} & {H}_{22} & {H}_{23} \\ {H}_{31} & {H}_{32} & {H}_{33}\end{matrix} ] \qquad ( 12 )$$

When the transformation matrix H is assumed to transform the coordinate value Pᵣ (xᵣ, yᵣ) on the comparison image to the coordinate value P_{w} (x_{w}, y_{w}) on the recognition failed image, the relationship between the Pᵣ and the P_{w} may be expressed as following Equation 13-1 using the general formula of projective transformation.

sPᵣ=HP_{w} (13-1)

The parameter s in Equation 13-1 represents a scaling factor based on uncertainty of the scaling. If Equation 13-1 is arranged for (x_{w}, y_{w}), the following Equations 13-2 and 13-3 may be obtained.

x_{w}=(H₁₁xᵣ+H₁₂yᵣ+H₁₃)/(H₃₁xᵣ+H₃₂yᵣ+H₃₃) (13-2)

y_{w}=(H₂₁xᵣ+H₂₂yᵣ+H₂₃)/(H₃₁xᵣ+H₃₂yᵣ+H₃₃) (13-3)

Here, since there is a degree of freedom of the magnification of the scalar, the degree of freedom of the matrix H is 8 degrees of freedom, and from this, it is assumed that H₃₃=1. Since the number unknowns is 8 and the equations may be generated for each pair of corresponding points, if the coordinates of at least four pairs of feature points are obtained, then, the unknowns are uniquely determined.

It is assumed that n pairs of feature points of which the matching is succeeded are obtained and that the coordinate of the iₜₕ feature point on the comparison image is Pᵣᵢ (xᵣᵢ, yᵣᵢ) and the coordinate of the feature point on the corresponding recognition failed image is P_{wi} (x_{wi}, y_{wi}), and the following Equations 14-1 and 14-2 are obtained.

H₁₁xᵣᵢ+H₁₂yᵣᵢ+H₁₃−H₃₁xᵣᵢx_{wi}−H₃₂yᵣᵢx_{wi}=x_{wi} (14-1)

H₂₁xᵣᵢ+H₂₂yᵣᵢ+H₂₃−H₃₁xᵣᵢy_{wi}−H₃₂yᵣᵢy_{wi}=y_{wi} (14-2)

An equation that is obtained by applying the above Equations 14-1 and 14-2 to the four pairs of feature points (i=1, 2, 3, and 4) is expressed as following Equation 15 in a matrix form.

$$[ \begin{matrix}{x}_{r 1} & {y}_{r 1} & 1 & 0 & 0 & 0 & ( - {x}_{r 1} {x}_{w 1} ) & ( - {y}_{r 1} {x}_{w 1} ) \\ 0 & 0 & 0 & {x}_{r 1} & {y}_{r 1} & 1 & ( - {x}_{r 1} {y}_{w 1} ) & ( - {y}_{r 1} {y}_{w 1} ) \\ {x}_{r 2} & {y}_{r 2} & 1 & 0 & 0 & 0 & ( - {x}_{r 2} {x}_{w 2} ) & ( - {y}_{r 2} {x}_{w 2} ) \\ 0 & 0 & 0 & {x}_{r 2} & {y}_{r 2} & 1 & ( - {x}_{r 2} {x}_{w 2} ) & ( - {y}_{r 2} {x}_{w 2} ) \\ {x}_{r 3} & {y}_{r 3} & 1 & 0 & 0 & 0 & ( - {x}_{r 3} {x}_{w 3} ) & ( - {y}_{r 3} {x}_{w 3} ) \\ 0 & 0 & 0 & {x}_{r 3} & {y}_{r 3} & 1 & ( - {x}_{r 3} {x}_{w 3} ) & ( - {y}_{r 3} {x}_{w 3} ) \\ {x}_{r 4} & {y}_{r 4} & 1 & 0 & 0 & 0 & ( - {x}_{r 4} {x}_{w 4} ) & ( - {y}_{r 4} {x }_{w 4} ) \\ 0 & 0 & 0 & {x}_{r 4} & {y}_{r 4} & 1 & ( - {x}_{r 4} {x}_{w 4} ) & ( - {y}_{r 4} {x}_{w 4} )\end{matrix} ] [ \begin{matrix}{H}_{11} \\ {H}_{12} \\ {H}_{13} \\ {H}_{21} \\ {H}_{22} \\ {H}_{23} \\ {H}_{31} \\ {H}_{32}\end{matrix} ] = [ \begin{matrix}{x}_{w 1} \\ {y}_{w 1} \\ {x}_{w 2} \\ {y}_{w 2} \\ {x}_{w 3} \\ {y}_{w 3} \\ {x}_{w 4} \\ {y}_{w 4} \end{matrix} ] \qquad ( 15 )$$

By substituting coordinate values for Pᵣᵢ and P_{wi} and by obtaining a reverse matrix, the values of H₁₁, . . . , H₃₂ may be obtained. In addition, in a case where five or more pairs of feature points are obtained, the unknowns may be obtained using a least-square method.

[Step S33] The comparison image information selection unit 116 substitutes the coordinate of the feature point on the comparison image for the calculated transformation matrix H with regard to each pair of feature points, and calculates a distance D between the transformed coordinate and the coordinate of the corresponding feature point on the recognition failed image.

[Step S34] The comparison image information selection unit 116 determines whether or not the calculated distance D satisfies following two determination conditions. As a first determination condition, it is determined that whether or not a minimum value Dmin of the calculated distance D is smaller than a threshold value Tdmin. As a second determination condition, it is determined whether or not the number of pairs of feature points of which the calculated distance D is equal to or larger than a threshold value Tdlim is equal to or smaller than a threshold value Tdnum. Any of the Tdmin, Tdlim, and Tdnum are larger than zero, and satisfy the relationship of Tdmin<Tdlim.

In a case where both of these first determination condition and second determination condition are satisfied, the comparison image selected in step S31 is determined to be suitable for calculating the imaging position and posture information. In this case, processing in step S35 is performed. In addition, in a case where at least one of the first determination condition or the second determination condition is not satisfied, the processing in step S31 is performed.

Although not illustrated, in a case where steps S31 to S34 are repeated, and the comparison image that satisfies both the first determination condition and the second determination condition does not exist, the processing ends similar to the case of the determination of “No” in step S28.

[Step S35] The comparison image information selection unit 116 reads the marker position information corresponding to the comparison image that is determined to be suitable for calculating the imaging position and posture information in step S34 from the comparison image information database 140. The comparison image information selection unit 116 substitutes the read marker position information, that is, the coordinates of four vertices for the transformation matrix H calculated in step S32 using the relevant comparison image, and performs the transformation. The transformed coordinate of each vertex indicates the estimated position of the coordinate of each vertex of the marker on the recognition failed image.

[Step S36] The marker position information transformed in step S35 is input to the imaging position and posture estimation unit 117. The imaging position and posture estimation unit 117 calculates the imaging position and posture information using the input marker position information after the transformation. In this way, the estimated value of the imaging position and posture information corresponding to the recognition failed image may be calculated.

[Step S37] The imaging position and posture information calculated in step S36 and the work ID specified in step S22 are input to the superimposed display control unit 114. The superimposed display control unit 114 specifies the work assist information that corresponds to the input work ID from the work assist information database 130. The superimposed display control unit 114 calculates the display position of the specified work assist information in the captured image using above-described Equations 1, 7-1, and 7-2, based on the input imaging position and posture information. The superimposed display control unit 114 causes the imaging position and posture information to be displayed on the calculated display position in the captured image.

In the above-described processing tasks illustrated in FIG. 10 to FIG. 12, in a case of failure in recognizing the marker, the terminal device 100 extracts the comparison image that is similar to the recognition failed image by performing the matching of the feature points with each other from the comparison images registered in the comparison image information database 140. Subsequently, it is possible to accurately determine the display position of the work assist information by calculating the imaging position and posture information using the information of the similar comparison image.

In addition, the terminal device 100 selects the comparison image that is appropriate for estimating the imaging position and posture information by evaluating the coordinate transformation accuracy using the transformation matrix H that transforms the coordinate from the comparison images that is determined to be similar to the recognition failed image. The accuracy of the display position of the work assist information is improved by calculating the imaging position and posture information using the selected comparison image.

The terminal device 100 in the second may be modified as follows.

Instead of registering the position information of the recognized marker in the comparison image information database 140 in step S15, the information accumulation control unit 115 registers the calculated imaging position and posture information in the comparison image information database 140 based on the position information of the marker. As the imaging position and posture information to be registered, the value calculated by the imaging position and posture estimation unit 113 is used.

In addition, following processing tasks are performed instead of those in step S35 and step S36 in FIG. 12. The imaging position and posture estimation unit 117 reads the imaging position and posture information that corresponds to the comparison image which is determined to be suitable for calculating the imaging position and posture information from the comparison image information database 140. Then, the imaging position and posture estimation unit 117 transforms the read imaging position and posture information using the transformation matrix H calculated in step S32. The imaging position and posture estimation unit 117 outputs the transformed imaging position and posture information to the superimposed display control unit 114.

Even in the processing tasks described above, it is possible to superimpose and display the work assist information on the accurately position. However, according to the processing tasks illustrated in FIG. 10 to FIG. 12, the processing load in transforming the marker position information using the transformation matrix H is much lower than that in transforming the imaging position and posture information using the transformation matrix H. Furthermore, in the case of transforming the marker position information using the transformation matrix H and then, calculating the imaging position and posture information using the transformed marker position information, the errors in transforming by the transformation matrix H decrease. Therefore, it is possible to improve the accuracy of the superimposed position of the work assist information.

### Third Embodiment

Next, a terminal device in a third embodiment will be described.

The terminal device in the third embodiment is a device in which a part of the terminal device 100 in the second embodiment is modified. Hereinafter, points which are different from those in the terminal device 100 in the second embodiment will be described.

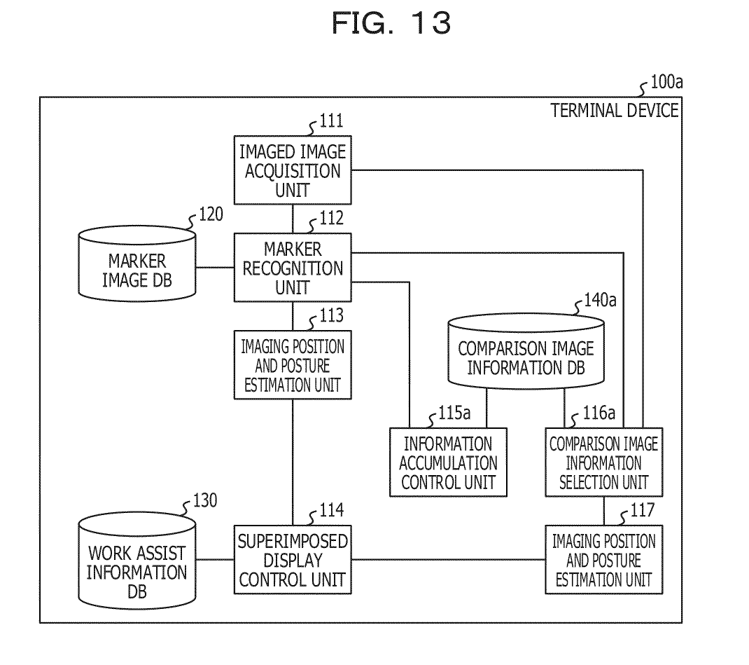

FIG. 13 is a block diagram illustrating an example of a configuration of processing functions included in the terminal device in the third embodiment. In FIG. 13, the same reference signs are given to the same elements in FIG. 8, and the description thereof will not be repeated.

A terminal device 100a illustrated in FIG. 13 is a device in which the information accumulation control unit 115, the comparison image information selection unit 116, and the comparison image information database 140 of the terminal device 100 illustrated in FIG. 8 are respectively replaced by an information accumulation control unit 115a, a comparison image information selection unit 116a, and a comparison image information database 140a.

As similar to the information accumulation control unit 115 in FIG. 8, in a case where the marker recognition unit 112 successfully recognizes the marker from the captured image, the information accumulation control unit 115a registers the information relating to the captured image in the comparison image information database 140a. However, the information accumulation control unit 115a also registers the imaging position and posture information calculated by the imaging position and posture estimation unit 113 in the comparison image information database 140a, in addition to the work ID, the position and the feature amount of the feature point, and the position information of the marker.

In addition, the information accumulation control unit 115a classifies the information items for each comparison image corresponding to the same work ID registered in the comparison image information database 140a into a plurality of groups. Furthermore, information accumulation control unit 115a selects a representative image from the comparison images that belong to each group.

In a case where the marker recognition unit 112 fails to recognize the marker from the captured image, firstly, the comparison image information selection unit 116a performs processing of matching the recognition failed image in which the recognition of the marker fails with the representative image of each group in the comparison image information database 140a. Then, comparison image information selection unit 116a excludes the groups to which the matching-failed representative image belongs from the processing target, and selects the information of an appropriate comparison image used for estimating the imaging position and posture information from the comparison target that belongs to the remaining groups by the processing similar to that of the comparison image information selection unit 116 in FIG. 8.

Here, a certain degree of constraint occurs in the imaging position or the imaging angle according to the surrounding environment of the position where the marker is installed such as the width of the path in front of the equipment on which the marker is installed or the positional relationships with the adjacent equipment, or the display position of the work assist information set with respect to the marker. For this reason, the information accumulation control unit 115 may classify the past captured image (comparison image) in which the same marker is successfully recognized, into the groups based on the imaging position and posture information calculated from the result of recognizing the marker.

In addition, in the processing of comparing the recognition failed image and the comparison image by the comparison image information selection unit 116, in a case where the difference in the imaging position and posture information between the images to be compared is large, the possibility of failure in matching the feature point between the images is high. Therefore, the comparison image in which the difference in the imaging position and posture information between the recognition failed images is large does not have to be the processing target of the matching.

For this reason, the comparison image information selection unit 116a performs the matching of the recognition failed image and the representative image of each classified group, and excludes the group to which the matching-failed representative image belongs from the subsequent processing. In this way, the number of processing tasks of matching decreases, and it is possible to decrease the processing load.

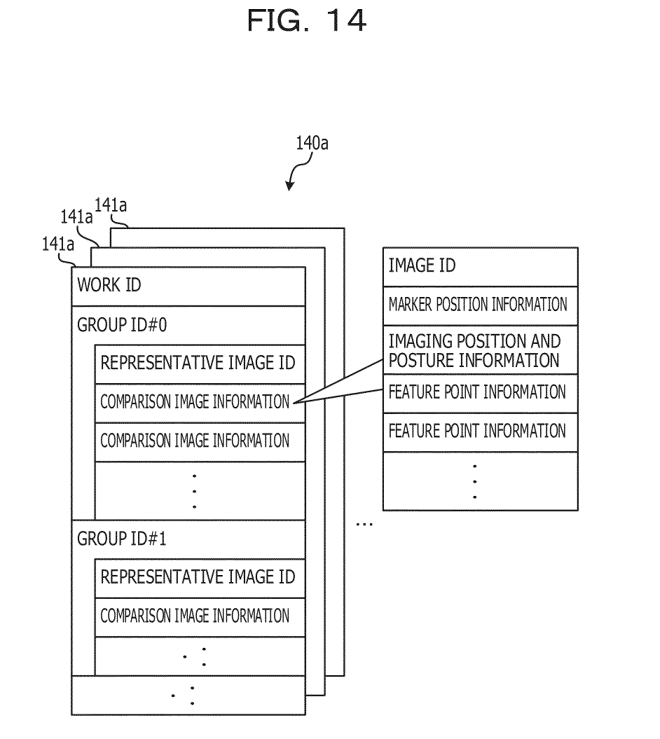

FIG. 14 is a diagram illustrating an example of a configuration of information recorded in a comparison image information database.

A record 141a is provided in the comparison image information database 140a for each work ID similar to the second embodiment. In addition, one or more comparison image information items are registered in each record 141a, and the comparison image information items thereof are classified for each group and registered. The group is identified by a group ID. Furthermore, a representative image ID is registered for each group. The representative image ID indicates the image ID given to the information corresponding to representative image among the comparison image information items that belongs to the group.

In addition, the imaging position and posture information is registered in the comparison image information in addition to the image ID, the marker position information, and a plurality of feature point information items. As the imaging position and posture information, the rotation matrix R and the translation vector T calculated by the imaging position and posture estimation unit 113 are registered as they are. In addition, for example, in order to make it easy to perform the grouping, the rotation matrix R and the translation vector T may be transformed to the camera position (x, y, z) with the center of the marker in the marker coordinate system as the reference and a rotation angle (rx, ry, rz) with three axes of the marker coordinate system as the reference, and may be registered in the comparison image information database 140a. In addition, as the rotation angle (rx, ry, rz), a rotation angle θ calculated by below-described Equation 18 may be used.

Next, among the processing tasks of the terminal device 100a, a portion that is different from the processing tasks illustrated in FIG. 10 to FIG. 12 will be described. First, the processing of the information accumulation control unit 115a will be described.

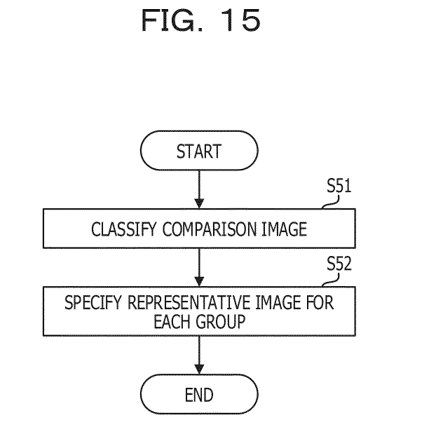

In a case where the marker recognition unit 112 successfully recognizes the marker, the information accumulation control unit 115a registers the imaging position and posture information calculated by the imaging position and posture estimation unit 113 in the comparison image information database 140a in addition to the work ID, the position and feature amount of the feature point, and the position information of the marker in step S15 in FIG. 10. In addition, the information accumulation control unit 115a performs following classification processing procedure illustrated in FIG. 15 on the information registered in the comparison image information database 140a for every certain time, for example.

FIG. 15 is a flowchart illustrating an example of a classification processing procedure by an information accumulation control unit. The processing in FIG. 15 is performed with respect to the comparison image information corresponding to the same work ID.

[Step S51] The information accumulation control unit 115a classifies the comparison images into the groups using the imaging position and posture information of each comparison image registered in the comparison image information database 140a. As a method of classification, a k-means method may be used. Here, in a case where the k-means method is used, if the camera position (x, y, z) and the rotation angle (rx, ry, rz) by the rotation matrix R and the translation vector T are used as the imaging position and posture information used in classifying calculation, it is possible to decrease the processing load.

The information accumulation control unit 115a updates the data in the comparison image information database 140 such that the comparison image may be classified for each group.

[Step S52] The information accumulation control unit 115a specifies the representative image for each classified group. For example, among the comparison images that belongs to the group, the information accumulation control unit 115a specifies the comparison image of which the camera position (x, y, z) or the rotation angle θ approaches closest to the center of gravity of the camera position (x, y, z) or the rotation angle θ of all the group, as the representative image. When the representative image is specified, the information accumulation control unit 115a registers the image ID of the representative image in a field of the representative image ID provided in the corresponding group in the comparison image information database 140.

Next, the processing of the comparison image information selection unit 116a is the processing in which the processing tasks in steps S21 to 28 and steps S31 to 35 in FIG. 11 and FIG. 12 by the comparison image information selection unit 116 are modified as follows.

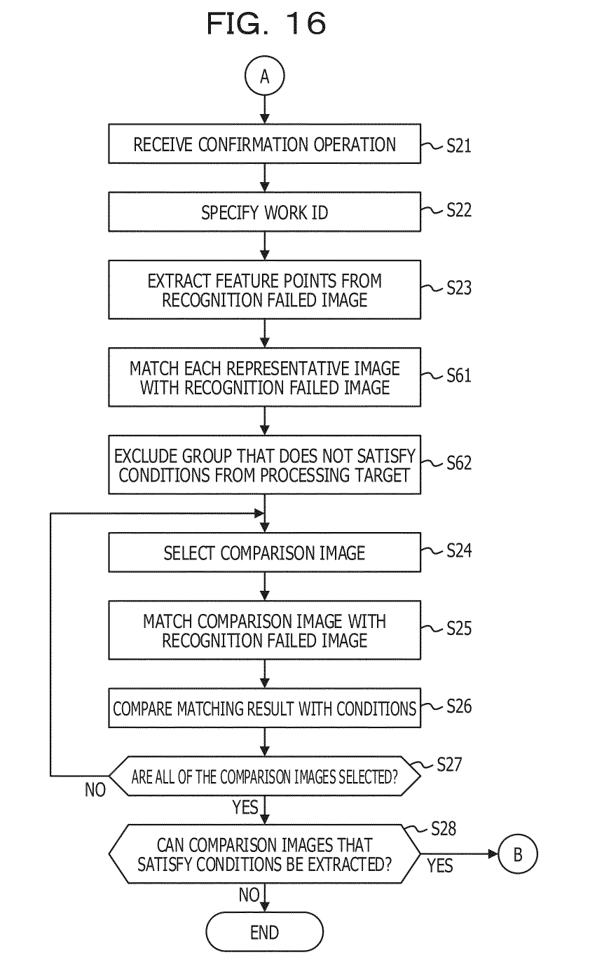

FIG. 16 is a flowchart illustrating a part of processing by a comparison image information selection unit in the third embodiment. In the processing in FIG. 16, steps S61 and S62 are added between step S23 and step S24 in FIG. 11.

[Step S61] The comparison image information selection unit 116a performs the matching of the feature point in each representative image for each group corresponding to the relevant work ID registered in the comparison image information database 140 and the feature point extracted from the recognition failed image. The method of matching and the method of determining whether or not the matching is succeeded is same to those in step S25.

The comparison image information selection unit 116a determines whether or not the result of matching with each representative image satisfies the following two determination conditions. As a first determination condition, it is determined whether or not a rate of the number of successful matches with respect to the total number of feature points extracted from the recognition failed image is larger than a threshold value Tb1 (here, Tb1 is larger than zero and equal to or smaller than one, and Tb1<Tb). As a second determination condition, it is determined whether or not the number of successful matches is larger than a threshold value Tc1 (here, Tc1 is larger than zero, and Tc1<Tc).

[Step S62] In a case where there exists a representative image that does not satisfy even one condition out of two conditions described above, the comparison image information selection unit 116a excludes the comparison image belongs to the group corresponding to that representative image from the processing target to be performed in subsequent to step S24.

As described above, in the third embodiment, in a case where the marker fails to be recognized, the terminal device 100a performs the matching of the recognition failed image with the representative image of each group classified based on the imaging position and posture information. Then, the group to which the matching-failed representative image belongs is excluded from the processing target to be subsequently performed. In this way, the number of processing tasks of matching decreases, and it is possible to decrease the processing load.

### Fourth Embodiment

Next, a terminal device in a fourth embodiment will be described. The terminal device in the fourth embodiment is a device in which a part of the terminal device 100a in the third embodiment is modified. Hereinafter, points which are different from those in the terminal device 100a in the third embodiment will be described.

The basic configuration of processing functions in the terminal device in the fourth embodiment is similar to those in the terminal device 100a illustrated in FIG. 13. Therefore, terminal device in the fourth embodiment will be described using the reference signs illustrated in FIG. 13.

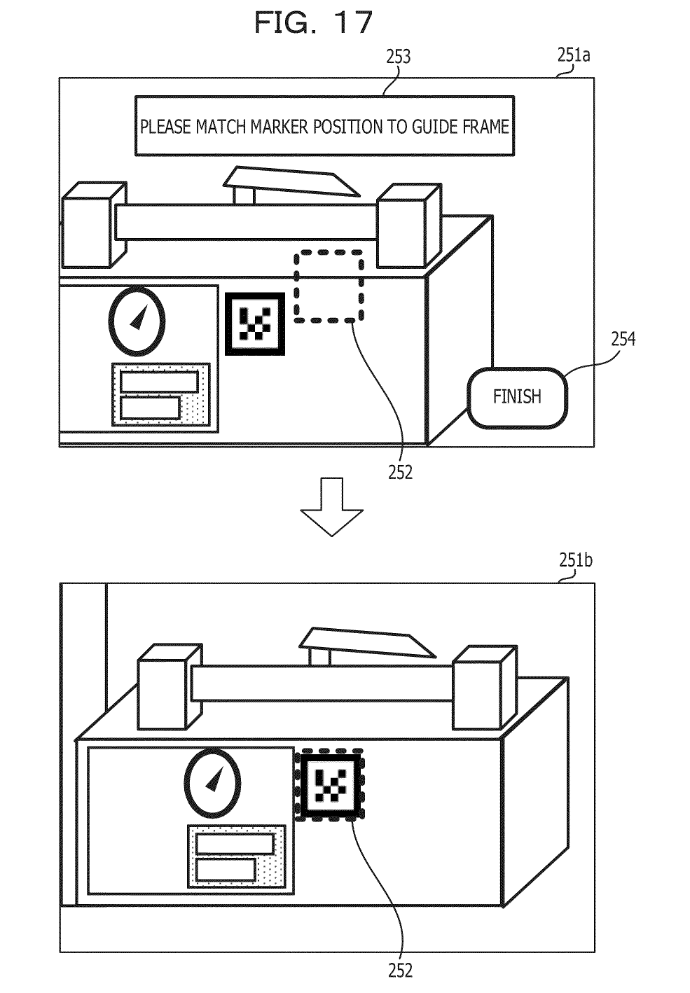

FIG. 17 is a diagram illustrating an example of a screen associated with a display of a guide frame.

When the marker fails to be recognized, the terminal device 100a in the fourth embodiment causes a guide frame 252 to be displayed in an captured image 251a on the display device 104 as illustrated in upper side of FIG. 17. Then, the terminal device 100a urges the worker to match the outer shapes of the marker reflected on the captured image 251a to the guide frame 252. For example, a guide image 253 for instructing the worker to perform such an operation is displayed on the captured image 251a. Furthermore, a finish button 254 for the worker to input the finishing of such operation is displayed on the captured image 251a.

In a case where the marker is not recognized in the terminal device 100a but the at least a part of the marker is visible through the captured image 251a, the worker changes the imaging position and the direction such that the outer shapes of the marker matches the guide frame 252. When the outer shapes of the marker match the guide frame 252, the worker presses the finish button 254 in that state. Then, as an captured image 251b illustrated in lower side of FIG. 17, the captured image which is in a state that the outer shapes of the marker matches the guide frame 252 is incorporated into the terminal device 100a. The terminal device 100a performs the determination of the position of superimposing the work assist information using the incorporated captured image as the recognition failed image.

Here, as similar to the third embodiment, the comparison image information classified for each work ID is further classified based on the imaging position and posture information and registered in the comparison image information database 140a of the terminal device 100a in the fourth embodiment. The comparison images that belongs to each group classified based on the imaging position and posture information are imaged in the similar imaging position and imaging direction for each group.

The terminal device 100a makes the shape, size, and the display position of the displayed guide frame 252 to be the same as the shape, size, and the display position of the marker recognized by the representative image of a certain group. In this case, the imaging position and direction when the marker on the captured image is matched to the guide frame 252 by the worker is similar to the imaging position and direction when the representative image that belongs to the above-described group is imaged. For this reason, in the processing of determining the superimposing position of the work assist information by the terminal device 100a, it is possible to obtain a sufficient superimposed position accuracy by only using the comparison image information that belongs to the above-described group.

Furthermore, as a group to be used, it is desirable that the group in which the number of registered comparison image information items is the largest is used. In this way, it is possible to use the multiple number of information items of the comparison image imaged in the imaging position and direction similar to the current imaging position and direction. As a result, the possibility of improving the superimposed position accuracy further increases than that in the case of using the comparison image information that belongs to other groups.

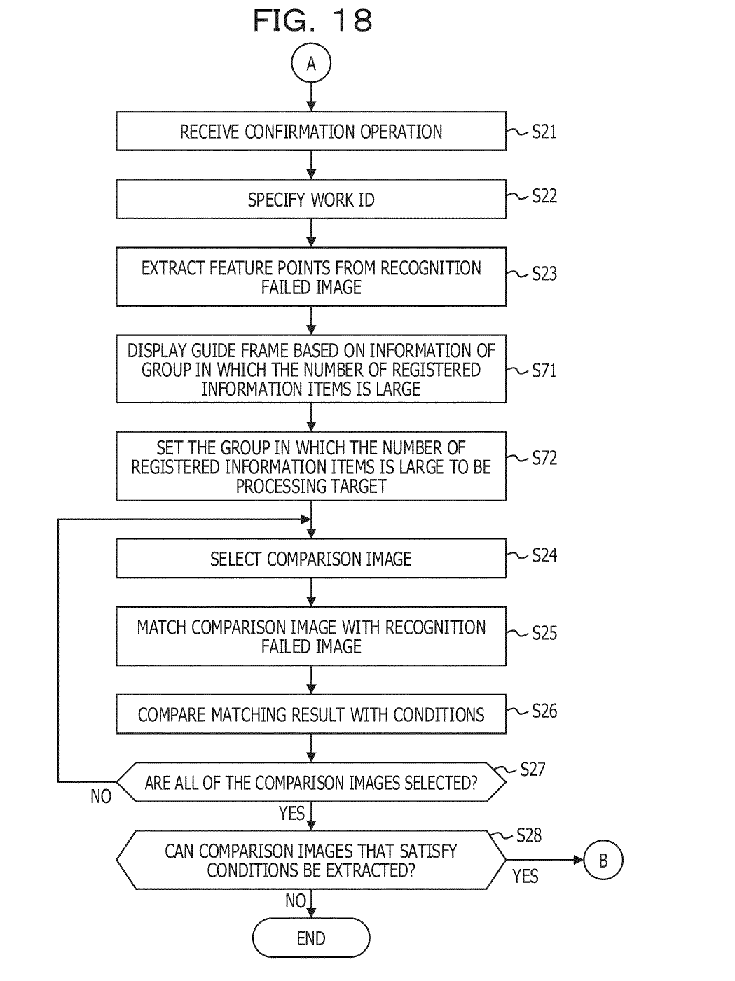

FIG. 18 is a flowchart illustrating a part of processing by the comparison image information selection unit in the fourth embodiment. In the processing in FIG. 18, steps S71 and S72 are added between step S23 and step S24 in FIG. 11.

[Step S71] The comparison image information selection unit 116a selects the group in which the number of registered comparison image information items is the largest from the record 141a corresponding to the relevant work ID in the comparison image information database 140a. The comparison image information selection unit 116a reads the marker position information corresponding to the representative image of the selected group from the above record 141a.

The comparison image information selection unit 116a causes the guide frame having the outer shape same as the marker that is indicated by the read marker position information to be displayed on the display device 104. Specifically, the coordinates of four vertices of the guide frame are made to be same as the coordinates of four vertices included in the read marker position information. In addition, as illustrated in FIG. 17, the image for instructing the worker to match the position of the marker with the position of the guide frame, or the operation button for the worker to perform the finishing operation is displayed.

[Step S72] When the worker performs the finishing the operation, the comparison image information selection unit 116a incorporates the captured image of that time point through the captured image acquisition unit 111, and makes the incorporated image to be the recognition failed image used in the subsequent processing. In addition, the comparison image information selection unit 116a makes only the comparison image information that belongs to the group selected in step S71 to be the processing target subsequent to step S24, and excludes the other comparison image information from the processing target.

In the fourth embodiment described above, it is possible to decrease the processing load by narrowing down the comparison image information used in the processing of determining the superimposing position while the accuracy of the superimposed position of the work assist information is maintained.

### Fifth Embodiment

Next, a terminal device in a fifth embodiment will be described. The terminal device in the fifth embodiment is a device in which a part of the terminal device 100a in the third embodiment is modified. Hereinafter, points which are different from those in the terminal device 100a in the third embodiment will be described.

The basic configuration of processing functions in the terminal device in the fifth embodiment is similar to that in the terminal device 100a illustrated in FIG. 13. Therefore, terminal device in the fifth embodiment will be described using the reference signs illustrated in FIG. 13.

A terminal device 100a in the fifth embodiment, when the marker fails to be recognized, urges the worker to input the outer shapes of the marker on the captured image. In a case where at least a part of the marker is visible through the captured image, the worker may input the outer shapes of the marker on the captured image. As a method of such inputting, for example, a method may be considered, in which the position of four vertices of the contour of the marker on the screen is input by the operation of touching or mouse click. In this way, the terminal device 100a acquires the information of the shape and position of the marker on the captured image.

From the comparison images corresponding to the relevant, the terminal device 100a extracts the comparison image from which the marker similar to (that is, having a high relationship with) the marker based on the input information is recognized, work ID. In this processing, terminal device 100a performs the matching of the information relating to the marker indicated by the input shape and position and the information relating to the representative images of each group corresponding to the relevant work ID. In this matching, for example, other than four vertices of the marker, for example, the imaging position and posture information based on the marker may be used.

The terminal device 100a selects, from the result of matching, the representative image of which the matching accuracy is equal to or higher than a certain value. Then, the terminal device 100a uses only the comparison image information that belongs to the group corresponding to the selected representative image in the processing of determining the position of superimposing the work assist information.

Incidentally, in the fifth embodiment, the imaging position and posture information may be registered in the comparison image information database 140a in the form of rotation matrix R and the translation vector T calculated by the imaging position and posture estimation unit 113. However, for example, the rotation matrix R is transformed to the rotation axis vector [rₓ, r_{y}, r_{z}] and the rotation angle θ, and the transformed rotation axis vector [rₓ, r_{y}, r_{z}] and the rotation angle θ may be registered in the comparison image information database 140a instead of the rotation matrix R. In this way, the optimized value for the matching is registered.

The relationships between the rotation matrix R calculated from the result of recognizing the marker and the rotation axis vector [rₓ, r_{y}, r_{z}] and the rotation angle θ is expressed as Equation 16 using the Rodrigues' formula.

$$sin ( θ ) [ \begin{matrix}0 & - {r}_{z} & {r}_{y} \\ {r}_{z} & 0 & - {r}_{x} \\ - {r}_{y} & {r}_{x} & 0\end{matrix} ] = ( R - {R}^{T )} ) / 2 \qquad ( 16 )$$

From the relationship in Equation 16, the rotation axis vector [rₓ, r_{y}, r_{z}] and the rotation angle θ may respectively be expressed as following Equations 17 and 18.

[rₓ r_{y} r_{z}]=∥(r₃₂−r₂₃)(r₁₃−r₃₁)(r₂₁−r₁₂)∥ (17)

θ=cos⁻¹((trace(R)−1)/2) (18)

Equation 17 is a normalized expression of the rotation axis. In addition, θ has value equal to or larger than zero and equal to or smaller than π. In addition, trace (R) in Equation 18 is a sum of the diagonal elements of R.

The matching processing using this rotation axis vector [rₓ, r_{y}, r_{z}] and the rotation angle θ will be described below.

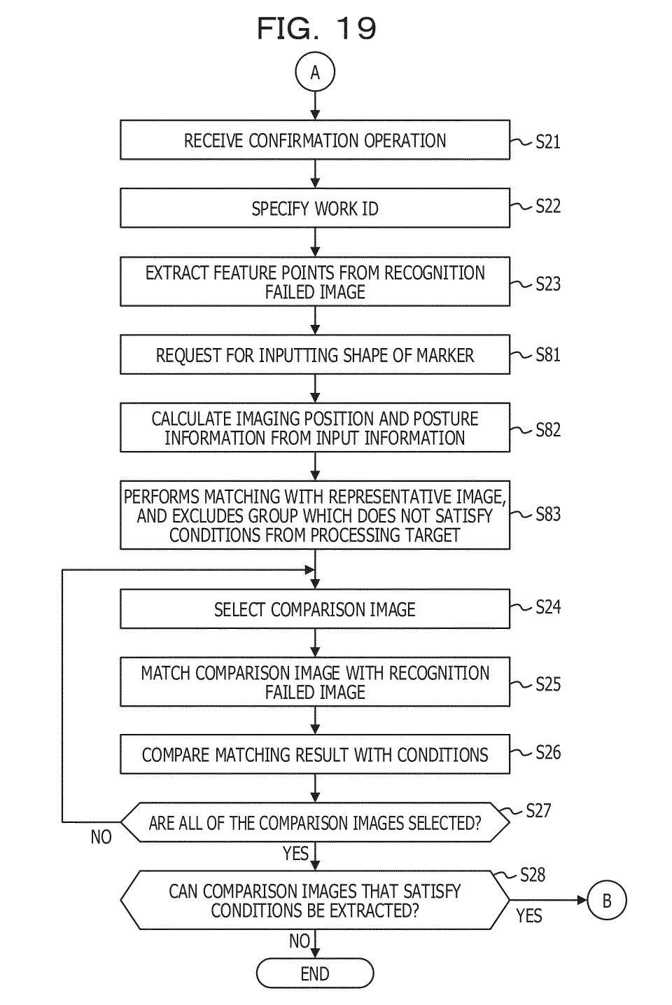

FIG. 19 is a flowchart illustrating a part of processing by a comparison image information selection unit in the fifth embodiment. In the processing in FIG. 19, steps S81 to S83 are added between step S23 and step S24 in FIG. 11.

[Step S81] The comparison image information selection unit 116a urges the worker to input the shape of the marker on the captured image. For example, the comparison image information selection unit 116a displays the image information that urges the worker such an input operation, on the display device 104. In addition, an operation button for notifying of the fact that the worker finished such an input operation is also displayed.

[Step S82] When the shape of the marker is input and the operation button is pressed by the worker, the comparison image information selection unit 116a incorporates the captured image from the captured image acquisition unit 111 and makes the incorporated image to be the recognition failed image used in the subsequent processing. In addition, the comparison image information selection unit 116a recognizes the coordinates of four vertices of the marker on the captured image based on the information input by the worker.

The comparison image information selection unit 116a calculates the imaging position and posture information corresponding to the shape of the input marker based on the recognized coordinates. For example, the comparison image information selection unit 116a calculates the rotation matrix R and the translation vector T in the procedure same as that by the imaging position and posture estimation unit 113 and 117. Furthermore, the comparison image information selection unit 116a calculates the rotation axis vector [rₓ, r_{y}, r_{z}] and the rotation angle θ based on the calculated rotation matrix R according to the above Equations 17 and 18.

[Step S83] The comparison image information selection unit 116a performs the matching of the information relating to the shape of the input marker with the information relating to the representative image of each group corresponding to the relevant work ID. In this matching, for example, the matching of the imaging position and posture information and the matching of the coordinates of four vertices are performed.

Here, as an example, firstly, the comparison image information selection unit 116a performs the matching with regard to each of the rotation axis vector [rₓ, r_{y}, r_{z}] and the translation component (component of the translation vector T) between the shape of the input marker and each representative image, and selects the representative images in which the matching accuracy is higher than a certain threshold value. Next, the comparison image information selection unit 116a performs the matching with regard to each of the rotation angle θ and the coordinates of four vertices, and further selects the representative images in which the matching accuracy is higher than a certain threshold value.

First, in the matching of the rotation axis vector [rₓ, r_{y}, r_{z}], an angle ω that makes the rotation axis vector [rₓ, r_{y}, r_{z}] which is based on the shape of the input marker and the representative image respectively, is calculated. This angle ω is regarded as the difference of the rotation axis vectors [rₓ, r_{y}, r_{z}]. In addition, in the matching of the translation component, the difference d in distances of the translation components is calculated.

The angle w that makes the rotation axis vector r₁=[rₓ₁, r_{y1}, r_{z1}] and r₂=[rₓ₂, r_{y2}, r_{z2}] is calculate by following Equation 19. In addition, the difference d in the distances of the translation components [tₓ₁, t_{y1}, t_{z1}] and [tₓ₂, t_{y2}, t_{z2}] is calculated by Equation 20.

$$\begin{matrix}ω = {cos}^{- 1} ( \frac{{r}_{1} - {r}_{2}}{\vert {r}_{1} \vert \vert {r}_{2} \vert} ) = {cos}^{- 1} ( \frac{{r}_{x 1} {r}_{x 2} + {r}_{y 1} {r}_{y 2} + {r}_{z 1} {r}_{z 2}}{\sqrt{{r}_{x 1}^{2} + {r}_{y 1}^{2} + {r}_{z 1}^{2}} \sqrt{{r}_{x 2}^{2} + {r}_{y 2}^{2} + {r}_{z 2}^{2}}} ) & ( 19 ) \\ d = \sqrt{( {t}_{x 2} - {t}_{x 1} ) + ( {t}_{y 2} - {t}_{y 1} ) + ( {t}_{z 2} - {t}_{z 1} )} & ( 20 )\end{matrix}$$

The comparison image information selection unit 116a selects the representative images in which the angle w that makes the rotation axis vector [rₓ, r_{y}, r_{z}] is equal to or smaller than a predetermined threshold value and in which the difference d in the distances of the translation components is equal to or smaller than the predetermined threshold value.

Next, between the shape of the input marker and the selected representative image, the comparison image information selection unit 116a calculates the difference in the rotation angle θ and the sum of the differences of each coordinate of four vertices. The comparison image information selection unit 116a selects the representative images in which the difference in the rotation angle θ is equal to or smaller than the predetermined threshold value and the sum of the differences of the coordinates of each vertex is equal to or smaller than the predetermined threshold value.

The comparison image information selection unit 116a extracts the representative image that satisfies all the conditions regarding the matching described above, and sets the comparison image that belongs to the group corresponding to the extracted representative image to the processing target subsequent to step S24. In addition, the comparison image information selection unit 116a excludes the comparison image that belongs to the group corresponding to the representative image that does not satisfy even one condition from the processing target subsequent to step S24.

By the processing described above, the terminal device 100a may decrease the processing load by narrowing down the comparison image information used in the processing of determining the superimposing position while the accuracy of the superimposed position of the work assist information is maintained.

In the processing in step S83, the matching processing may be performed by at least one or combination of two or more parameters among the parameters of the rotation axis vector [rₓ, r_{y}, r_{z}], the translation component, the rotation angle θ, and the coordinates of four vertices.

In addition, in step S83, instead of the representative image, all the comparison images associated with the relevant work ID may be the target image to be matched with the shape of the input marker. In this case, the comparison images that satisfy the condition of matching accuracy becomes the processing target subsequent to step S24 and the other comparison images are excluded from the processing target.

The processing functions of the devices (display control device 1 and the terminal device 100 and 100a) describe in each of the above embodiments may be realized by a computer. In such a case, a program in which the processing content of the functions included in each device is provided, and the processing functions are realized in the computer by executing the program in the computer. The program describing the processing content may be recorded in the computer-readable recording medium. As the computer-readable recording medium, there are a magnetic storage device, an optical disk, a magneto-optical recording medium, a semiconductor memory, and the like. As the magnetic storage device, there are a hard disk device (HDD), a flexible disk (FD), a magnetic tape, and the like. As the optical disk, there are a digital versatile disc (DVD), a DVD-RAM, a compact disc-read only memory (CD-ROM), CD-R (recordable)/RW (rewritable), and the like. As the magneto-optical recording medium, there are magneto-optical disk (MO), and the like.

In a case of distributing the program, for example, a portable recording medium such as a DVD, CD-ROM in which the program is recorded is sold. In addition, the program is stored in a storage device of the server computer, and the program may be transmitted to another computer from the server computer via a network.

The computer that executes the program stores the program recorded in the portable recording medium or the program transmitted from the server computer in the storage device of itself. Then, the computer reads the program from the storage device of itself, and executes the processing according to the program. The computer may also read the program directly from the portable recording medium and executes the processing according to the program. In addition, the computer may also sequentially execute the program according to the received program for each transmission of the program from the server computer connected to itself via the network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display control device that calculates an imaging position and an imaging posture of a camera capturing a plurality of captured images with a marker as a reference based on position information of the marker recognized from the captured images, and superimposes and displays augment information on the captured image based on the calculated imaging position and the imaging posture of the camera, the device comprising:
a memory; and
a processor to execute a plurality of instructions stored in the memory to perform:
acquiring
a second captured image captured by the camera on which the augment information is to be superimposed and displayed, and
a plurality of first captured images captured by the camera that is captured at a time different from that of the second captured image, and on which the augment information is to be superimposed and displayed;
storing an image feature information, respectively of the first captured images which is used for calculating a degree of similarity of at least one of the first captured image and the second captured image in a storage, in a case where the marker included in the first captured images are recognized;
calculating the imaging position and the imaging posture corresponding to the second captured image based on the image feature information, in a case where the marker included in the second captured image fails to be recognized; and
determining, a display position of superimposition of the augment information related to the second captured image based on the calculated imaging position and the calculated imaging posture calculated by the calculating, when the marker included in the second captured image is failed to be recognized.

2. The device according to claim 1,
wherein the storing further stores position information of the marker included in the first captured images, respectively which is based on recognizing the marker from the first captured images.

3. The device according to claim 2, further comprising:
extracting, from the storage, the position information corresponding to at least one of the first captured images which is similar to the second captured image based on the image feature, in the case where the marker included in the second captured image fails to be recognized,
wherein the extracting calculates the imaging position and the imaging posture of the camera corresponding to the second captured image based on the position information extracted by the extracting.

4. The device according to claim 3,
wherein the extracting extracts, from the storage, the image feature corresponding to the first captured image which is similar to the second captured image, and
wherein the calculating
calculates transformation equation that transforms a coordinate of a plurality of feature points in the first captured image to a coordinate of a plurality of feature points in the second captured image based on the image feature extracted by the extracting, and calculates an evaluation value of the coordinate transformation by the transformation equation, and
calculates the imaging position and the imaging posture of the camera based on the position information corresponding to the second captured image in the case where the evaluation value satisfies a predetermined condition.

5. The device according to claim 4,
wherein, in a case where the evaluation value satisfies the predetermined condition, the calculating transforms the position information of the marker included in the position information corresponding to the first captured image using the transformation equation, and calculates the imaging position and the imaging posture of the camera based on the transformed position information of the marker.

6. The device according to claim 5,
wherein the extracting extracts, from the storage, the image feature corresponding to the first captured image which is similar to the second captured image, and
wherein the calculating
calculates the transformation equation that transforms a coordinate of a plurality of feature points in the first captured image to a coordinate of a plurality of feature points in the second captured image based on the image feature extracted by the extracting, and
transforms the position information of the marker included in the image feature corresponding to the first captured image using the transformation equation, and calculates the imaging position and the imaging posture of the camera based on the transformed position information of the marker.

7. The device according to claim 6,
wherein the storing classifies the image feature and the position information into a plurality of groups based on the imaging position and the imaging posture calculated from the first captured image and records, and
wherein the extracting, using the image feature that is selected one by one from each of the plurality of groups,
extracts the first captured image which is similar to the second captured image from the captured images respectively corresponding to the selected image feature, and
selects a group to which the extracted first captured image belongs, and extracts at least one first captured image which is similar to the second captured image from the plurality of first captured images corresponding to the image feature included in the group using the plurality of image feature items included in the selected group.

8. The device according to claim 7,
wherein the extracting,
in a case where the marker included in the second captured image fails to be recognized, selects a group in which the largest number of image feature and the position information items are included among the plurality of groups, selects one position information from the selected group, and causes a guide frame having a shape and size same to the outer shape of the marker which is based on the selected position information to be displayed on the position same to the position of the marker on the first captured image, and
extracts the first captured image which is similar to the second captured image incorporated after the display of the guide frame from the first captured images corresponding to the image feature included in the group using the plurality of image feature items included in the group selected using the second captured image incorporated after the display of the guide frame.

9. The device according to claim 8,
wherein the extracting
receives operation inputting information of the shape and position of the marker in the second captured image in a case where the marker fails to be recognized from the second captured image,
compares the position information selected one by one from the plurality of groups and the information relating to the marker which is based on the input position information, and determines the first captured image from which the marker in which an index indicating the relationships with the marker which is based on the position information satisfies the predetermined condition is recognized from the plurality of first captured images corresponding to the selected position information, and
extracts the first captured image which is similar to the second captured image from the captured images corresponding to the image feature included in the group using the plurality of image feature items included in the group to which the first captured image belongs.

10. A display control method in which an imaging position and an imaging posture of a camera capturing a plurality of captured images with a marker as a reference is calculated based on position information of a marker recognized from the captured image, and augment information is superimposed and displayed on the captured image based on the calculated imaging position and the imaging posture of the camera, the method comprising:
acquiring
a second captured image captured by the camera on which the augment information is to be superimposed and displayed, and
a plurality of first captured images captured by the camera that is captured at a time different from that of the second captured image, and on which the augment information is to be superimposed and displayed;
storing an image feature information, respectively of the first captured images which is used for calculating a degree of similarity of at least one of the first captured image and the second captured image in a storage, in a case where the marker included in the first captured images are recognized;
calculating, by a processor, the imaging position and the imaging posture corresponding to the second captured image based on the image feature information, in a case where the marker included in the second captured image fails to be recognized; and
determining, a display position of superimposition of the augment information related to the second captured image based on the calculated imaging position and the calculated imaging posture calculated by the calculating, when the marker included in the second captured image is failed to be recognized.

11. The method according to claim 10,
wherein the storing further stores position information of the marker included in the first captured images, respectively which is based on recognizing the marker from the first captured images.

12. The method according to claim 11, further comprising:
extracting, from the storage, the position information corresponding to at least one of the first captured images which is similar to the second captured image based on the image feature, in the case where the marker included in the second captured image fails to be recognized,
wherein the extracting calculates the imaging position and the imaging posture of the camera corresponding to the second captured image based on the position information extracted by the extracting.

13. The method according to claim 12,
wherein the extracting extracts, from the storage, the image feature corresponding to the first captured image which is similar to the second captured image, and
wherein the calculating
calculates transformation equation that transforms a coordinate of a plurality of feature points in the first captured image to a coordinate of a plurality of feature points in the second captured image based on the image feature extracted by the extracting, and calculates an evaluation value of the coordinate transformation by the transformation equation, and
calculates the imaging position and the imaging posture of the camera based on the position information corresponding to the second captured image in the case where the evaluation value satisfies a predetermined condition.

14. The method according to claim 13,
wherein, in a case where the evaluation value satisfies the predetermined condition, the calculating transforms the position information of the marker included in the position information corresponding to the first captured image using the transformation equation, and calculates the imaging position and the imaging posture of the camera based on the transformed position information of the marker.

15. The method according to claim 14,
wherein the extracting extracts, from the storage, the image feature corresponding to the first captured image which is similar to the second captured image, and
wherein the calculating
calculates the transformation equation that transforms a coordinate of a plurality of feature points in the first captured image to a coordinate of a plurality of feature points in the second captured image based on the image feature extracted by the extracting, and
transforms the position information of the marker included in the image feature corresponding to the first captured image using the transformation equation, and calculates the imaging position and the imaging posture of the camera based on the transformed position information of the marker.

16. The method according to claim 15,
wherein the storing classifies the image feature and the position information into a plurality of groups based on the imaging position and the imaging posture calculated from the first captured image and records, and
wherein the extracting, using the image feature that is selected one by one from each of the plurality of groups,
extracts the first captured image which is similar to the second captured image from the captured images respectively corresponding to the selected image feature, and
selects a group to which the extracted first captured image belongs, and extracts at least one first captured image which is similar to the second captured image from the plurality of first captured images corresponding to the image feature included in the group using the plurality of image feature items included in the selected group.

17. The method according to claim 16,
wherein the extracting,
in a case where the marker included in the second captured image fails to be recognized, selects a group in which the largest number of image feature and the position information items are included among the plurality of groups, selects one position information from the selected group, and causes a guide frame having a shape and size same to the outer shape of the marker which is based on the selected position information to be displayed on the position same to the position of the marker on the first captured image, and
extracts the first captured image which is similar to the second captured image incorporated after the display of the guide frame from the first captured images corresponding to the image feature included in the group using the plurality of image feature items included in the group selected using the second captured image incorporated after the display of the guide frame.

18. The method according to claim 17,
wherein the extracting
receives operation inputting information of the shape and position of the marker in the second captured image in a case where the marker fails to be recognized from the second captured image,
compares the position information selected one by one from the plurality of groups and the information relating to the marker which is based on the input position information, and determines the first captured image from which the marker in which an index indicating the relationships with the marker which is based on the position information satisfies the predetermined condition is recognized from the plurality of first captured images corresponding to the selected position information, and
extracts the first captured image which is similar to the second captured image from the captured images corresponding to the image feature included in the group using the plurality of image feature items included in the group to which the first captured image belongs.

19. A computer-readable non-transitory storage medium storing a display control program that calculates an imaging position and an imaging posture of a camera capturing a plurality of captured images with a marker as a reference based on position information of the marker recognized from the captured images, and superimposes and displays augment information on the captured image based on the calculated imaging position and the imaging posture of the camera, and that causing a computer to execute a process comprising:
acquiring
a second captured image captured by the camera on which the augment information is to be superimposed and displayed, and
a plurality of first captured images captured by the camera that is captured at a time different from that of the second captured image, and on which the augment information is to be superimposed and displayed;
storing an image feature information, respectively of the first captured images which is used for calculating a degree of similarity of at least one of the first captured image and the second captured image in a storage, in a case where the marker included in the first captured images are recognized;
calculating the imaging position and the imaging posture corresponding to the second captured image based on the image feature information, in a case where the marker included in the second captured image fails to be recognized; and
determining, a display position of superimposition of the augment information related to the second captured image based on the calculated imaging position and the calculated imaging posture calculated by the calculating, when the marker included in the second captured image is failed to be recognized.
